(19) United States
(12) Patent Application Publication
(10) Pub. No.: US 2026/0301682 A1
(43) Pub. Date: Oct. 1, 2026

(54) STAGE CIRCUIT AND DISPLAY DEVICE INCLUDING THE SAME, AND ELECTRONIC DEVICE

(71) Applicant: Samsung Display Co., Ltd., Yongin-Si (KR)

(72) Inventors: Kyung Ho KIM, Yongin-si (KR); Hyeong Seok KIM, Yongin-si (KR); Dong Hee SHIN, Yongin-si (KR); Jung Hwan HWANG, Yongin-si (KR)

(21) Appl. No.: 19/413,337

(22) Filed: Dec. 9, 2025

(30) Foreign Application Priority Data
Mar. 28, 2025 (KR) 10-2025-0040634

(51) Int. Cl. G09G 3/3266; G09G 3/32

(52) U.S. Cl. CPC G09G 3/3266; G09G 3/32; G09G 2300/0819; G09G 2310/0267; G09G 2320/0233; G09G 2330/021; G09G 2330/022

(57) ABSTRACT

A stage circuit includes a driver configured to control voltages of a first node and a second node, a controller connected to the driver and configured to control a voltage of a connection control line, a plurality of output units disposed in the stage circuit and configured to output an enable scan signal or an enable initialization signal in response to a voltage of a local node connected to each of the plurality of output units, a plurality of connecting configured to control an electrical connection between the first node and the local node connected to each of the plurality of connecting units in response to the voltage of the connection control line, and a reset unit configured to control the voltage of the connection control line.

### CROSS-REFERENCE TO RELATED APPLICATION

This application claims priority under 35 U.S.C. § 119(a) to Korean Patent Application No. 10-2025-0040634, filed on Mar. 28, 2025, in the Korean Intellectual Property Office, the disclosure of which is incorporated herein by reference in its entirety.

### BACKGROUND

### (a) Technical Field

Various embodiments of the present disclosure relate to a stage circuit, a display device including the same, and an electronic device.

### (b) Description of Related Art

As information technology has developed, the importance of display devices, which serve as medium connection users and information, has been highlighted. Accordingly, the use of display devices such as liquid crystal display devices, organic light emitting display devices, and the like has increased.

The display devices include pixels. Each of the pixels may receive a data signal in response to a scan signal supplied from a scan driver, and may emit light of luminance corresponding to the data signal. The scan driver may include a plurality of stage circuits to supply the scan signal.

### SUMMARY

Various embodiments of the present disclosure provide a stage circuit capable of minimizing a mounting area, a display device including the same, and an electronic device.

According to an embodiment, a stage circuit includes a driver connected to a first power input terminal, a second power input terminal, a third power input terminal and a fourth power input terminal, and configured to control voltages of a first node and a second node, a controller connected to the first power input terminal, the second power input terminal, a first carry input terminal, a second carry input terminal, an initialization terminal and the driver, and configured to control a voltage of a connection control line, a plurality of output units disposed in the stage circuit, wherein each of the plurality of output units is configured to output an enable scan signal or an enable initialization signal in response to a voltage of a local node connected to each of the plurality of output units, a plurality of connecting units connected to the plurality of output units, wherein each of the plurality of connecting units is configured to control an electrical connection between the first node and the local node connected to each of the plurality of connecting units in response to the voltage of the connection control line, and a reset unit connected to the second node, the second power input terminal, a fifth power input terminal and a reset input terminal to control the voltage of the connection control line.

In an embodiment, first power may be input through the first power input terminal, second power may be input through the second power input terminal, third power may be input through the third power input terminal, fourth power may be input through the fourth power input terminal, and fifth power may be input through the fifth power input terminal. The second power may have a positive voltage lower than a voltage of the first power, and the third power, the fourth power and the fifth power may have negative voltages.

In an embodiment, the fifth power may have a same voltage as the third power or the fourth power.

In an embodiment, the reset unit may further include at least one first reset transistor connected between the connection control line and the fifth power input terminal, and including a gate electrode connected to the second node, and a second reset transistor connected between the connection control line and the second power input terminal, and including a gate electrode connected to the reset input terminal.

In an embodiment, each of the plurality of connecting units may electrically connect the first node to the local node during a first period when the first node has a high-level voltage, and may disconnect the first node from the local node during a second period when the first node has a voltage higher than the high-level voltage.

In an embodiment, the stage circuit may further include a carry output unit connected to a carry clock input terminal and the third power input terminal, and configured to connect a carry output terminal to the carry clock input terminal or to the third power input terminal in response to the voltages of the first node and the second node.

In an embodiment, the carry clock signal input through the carry clock input terminal may be supplied as a carry signal of the stage circuit to a previous stage circuit and a next stage circuit. A carry signal from the previous stage circuit may be input through the first carry input terminal, and a carry signal from the next stage circuit may be input through the second carry input terminal.

In an embodiment, the carry output unit may include a first carry transistor connected between the carry clock input terminal and the carry output terminal, and including a gate electrode connected to the first node, and a second carry transistor connected between the carry output terminal and the third power input terminal, and including a gate electrode connected to the second node.

In an embodiment, the stage circuit may further include a boosting unit connected to a boosting clock input terminal, through which a boosting clock signal is input, and the third power input terminal, and configured to connect a voltage control line to the boosting clock input terminal or to the third power input terminal in response to the voltages of the first node and the second node.

In an embodiment, the boosting unit may include a first boosting transistor connected between the boosting clock input terminal and the voltage control line, and including a gate electrode connected to the first node, a second boosting transistor connected between the voltage control line and the third power input terminal, and including a gate electrode connected to the second node, and a first capacitor connected between the first node and the voltage control line.

In an embodiment, each of the plurality of connecting units may include a switching transistor connected between the first node and the local node, and including a gate electrode connected to the connection control line, and a boosting capacitor connected between the voltage control line and the local node.

In an embodiment, the controller may include a control transistor connected between the driver and the connection control line, and including a gate electrode connected to the initialization terminal, a first control transistor connected between the first power input terminal and the connection control line, and including a gate electrode connected to the first carry input terminal, a second control transistor connected between the second power input terminal and the connection control line, and including a gate electrode connected to the voltage control line, and a third control transistor connected between the second power input terminal and the connection control line, and including a gate electrode connected to the second carry input terminal.

In an embodiment, the driver may include a first transistor connected between the first power input terminal and a third node, a second transistor connected between the third node and the first node, and including a gate electrode connected to the initialization terminal, and a holding capacitor connected between the first power input terminal and a gate electrode of the first transistor.

In an embodiment, the control transistor may be connected between the third node and the connection control line.

In an embodiment, each of the plurality of output units may include a first output transistor connected between a scan clock input terminal, through which one of the plurality of scan clock signals is input, and an output terminal, and including a gate electrode connected to the local node, and a second output transistor connected between the fourth power input terminal and the output terminal, and including a gate electrode connected to the second node.

According to an embodiment, a display device includes pixels connected to scan lines, initialization lines and data lines, and a scan driver including a plurality of stage circuits for supplying an enable scan signal to the scan lines and an enable initialization signal to the initialization lines. At least one of the plurality of stage circuits includes a driver connected to a first power input terminal, a second power input terminal, a third power input terminal and a fourth power input terminal, and configured to control voltages of a first node and a second node, a controller connected to the first power input terminal, the second power input terminal, a first carry input terminal, a second carry input terminal, an initialization terminal and the driver, and configured to control a voltage of a connection control line, a plurality of output units disposed in the one of the plurality of stage circuits, wherein each of the plurality of output units is configured to output the enable scan signal or the enable initialization signal in response to a voltage of a local node connected to each of the plurality of output units, a plurality of connecting units connected to the plurality of output units, wherein each of the plurality of connecting units is configured to control an electrical connection between the first node and the local node connected to each of the plurality of connecting units in response to the voltage of the connection control line, and a reset unit connected to the second node, the second power input terminal, a fifth power input terminal and a reset input terminal to control the voltage of the connection control line.

In an embodiment, first power may be input through the first power input terminal, second power may be input through the second power input terminal, third power may be input through the third power input terminal, fourth power may be input through the fourth power input terminal, and fifth power may be input through the fifth power input terminal. The second power may have a positive voltage lower than a voltage of the first power, and the third power, the fourth power and the fifth power may have negative voltages.

In an embodiment, the fifth power may have a same voltage as the third power or the fourth power.

In an embodiment, the reset unit may include at least one first reset transistor connected between the connection control line and the fifth power input terminal, and including a gate electrode connected to the second node, and a second reset transistor connected between the connection control line and the second power input terminal, and including a gate electrode connected to the reset input terminal.

In an embodiment, each of the plurality of connecting units may electrically connect the first node to the local node during a first period when the first node has a high-level voltage, and may disconnect the first node from the local nodes during a second period when the first node has a voltage higher than the high-level voltage.

According to an embodiment, an electronic device includes a processor, a display module displaying an image based on image data supplied from the processor, pixels included in the display module, and connected to scan lines, initialization lines and data lines, and a scan driver included in the display module, and including a plurality of stage circuits for supplying an enable scan signal to the scan lines and an enable initialization signal to the initialization lines. At least one of the plurality of stage circuits includes a driver connected to a first power input terminal, a second power input terminal, a third power input terminal and a fourth power input terminal, and configured to control voltages of a first node and a second node, a controller connected to the first power input terminal, the second power input terminal, a first carry input terminal, a second carry input terminal, an initialization terminal and the driver, and configured to control a voltage of a connection control line, a plurality of output units disposed in the one of the plurality of stage circuits, wherein each of the plurality of output units is configured to output the enable scan signal or the enable initialization signal in response to on voltages of a local node connected to each of the plurality of output units, a plurality of connecting units connected to the plurality of output units, wherein each of the plurality of connecting units is configured to control an electrical connection between the first node and the local node connected to each of the plurality of connecting units in response to the voltage of the connection control line, and a reset unit connected to the second node, the second power input terminal, a fifth power input terminal and a reset input terminal to control the voltage of the connection control line.

The technical features of the present disclosure are not limited to those mentioned above, and other technical features that are not mentioned will be apparent to those skilled in the art from the following descriptions.

### BRIEF DESCRIPTION OF THE DRAWINGS

FIG. 1 is a diagram illustrating a display device according to an embodiment of the present disclosure.

FIG. 2 is a schematic diagram of an equivalent circuit of a pixel shown in FIG. 1.

FIG. 3 is a diagram illustrating a scan driver shown in FIG. 1.

FIG. 4 is a block diagram of a stage circuit according to an embodiment of the present disclosure.

FIG. 5 is a schematic diagram of an equivalent circuit of a controller, a boosting unit, a carry output unit, output units, and connecting units of a stage circuit shown in FIG. 4.

FIG. 6 is a waveform diagram illustrating a method of driving a stage circuit shown in FIG. 5.

FIGS. 7A to 7C are diagrams illustrating an operation of a stage circuit corresponding to the driving waveform of FIG. 6.

FIG. 8 is a diagram illustrating a driver of a stage circuit shown in FIG. 4.

FIG. 9 is a waveform diagram illustrating an operation of a driver shown in FIG. 8.

FIG. 10 is a diagram illustrating a reset signal supplied during a sensing period.

FIG. 11 is a diagram illustrating an electronic device according to an embodiment of the present disclosure.

FIGS. 12 to 15 are diagrams illustrating examples of an electronic device according to various embodiments.

### DETAILED DESCRIPTION

Hereinafter, embodiments of the present disclosure will be described in detail with reference to the attached drawings, such that those skilled in the art can easily implement the present disclosure. The present disclosure may be implemented in various forms, and is not limited to the embodiments to be described herein below.

In the drawings, portions which are not related to the present disclosure will be omitted in order to explain the present disclosure more clearly. It is noted that the same or similar reference numeral may designate the same or similar components throughout the drawings. Therefore, the aforementioned reference numerals may be used in other drawings.

Furthermore, the expression “being the same” may mean “being substantially the same”. In other words, the expression “being the same” may embrace a range that can be tolerated by those skilled in the art. The other expressions may also be construed as implicitly include “substantially” in front of the expressions.

Embodiments may be described with reference to the accompanying drawings illustrating functional blocks, units, and/or modules. Those skilled in the art will appreciate that such blocks, units, and/or modules are physically implemented with logic circuits, separate components, microprocessors, hard wire circuits, memory devices, wiring connections, and other electronic circuits. Such blocks, units, and/or modules may be formed using semiconductor-based manufacturing techniques or other manufacturing techniques. In the case of blocks, units and/or modules implemented with microprocessors or other similar hardware, such blocks, units, and/or modules may be programmed and controlled using software to perform various functions discussed in the present disclosure, and may optionally be driven by firmware and/or software. In addition, each block, unit, and/or module may be implemented with dedicated hardware, or may be implemented with a combination of dedicated hardware performing some functions and a processor (e.g., one or more programmed microprocessors and associated circuit) performing other functions. In addition, blocks, units, and/or modules may be physically separated into two or more separate blocks, units, or modules that interact without departing from the scope of the inventive concept of the present disclosure. In addition, blocks, units, and/or modules may be physically combined into more complex blocks, units, or modules without departing from the scope of the inventive concept of the present disclosure.

The term “connection” between two elements may mean, but is not necessarily limited to, the comprehensive use of both electrical and physical connections. For example, a “connection” used with reference to a circuit diagram may mean an electrical connection, and a “connection” used with reference to a cross-sectional view or a plan view may mean a physical connection.

It will be understood that, although the terms “first”, “second”, or the like may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

The present disclosure is not limited to embodiments disclosed below, and may be implemented in various forms. In addition, each of the embodiments disclosed below may be practiced alone or in combination with one or more other embodiments.

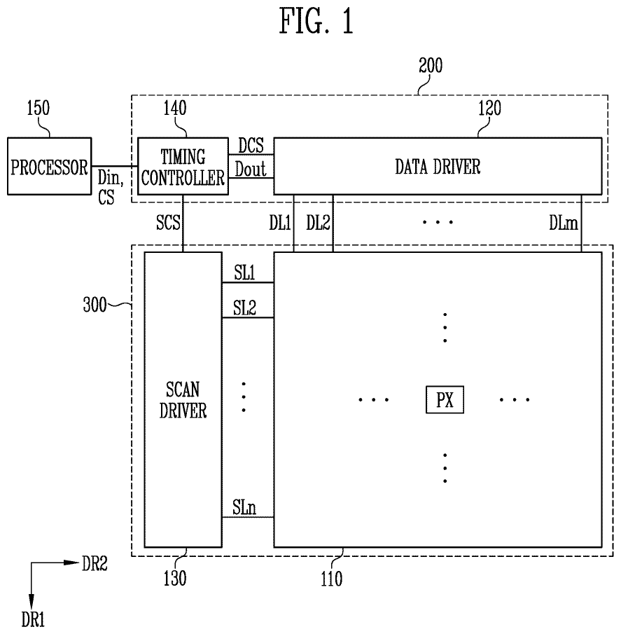

FIG. 1 is a diagram illustrating a display device according to an embodiment of the present disclosure.

Referring to FIG. 1, the display device according to an embodiment of the present disclosure may include a display driver 200 and a display unit 300.

The display driver 200 may control the display unit 300. To control the display unit 300, the display driver 200 may include a timing controller 140 and a data driver 120. The display driver 200 may be implemented as a single integrated circuit (IC) or a plurality of ICs. The display unit 300 may display a predetermined image. To display the image, the display unit 300 may include a pixel portion 110 and a scan driver 130.

The timing controller 140 may receive input data Din and control signals CS corresponding to each frame from a processor 150. The processor 150 may correspond to a Graphics Processing Unit (GPU), a Central Processing Unit (CPU), an Application Processor (AP), or the like. The control signals CS may include various signals necessary for driving the display device. The input data Din may correspond to the image displayed in the pixel portion 110.

The timing controller 140 may rearrange the input data Din to meet the specifications of the display device. In addition, the timing controller 140 may generate output data Dout by correcting the input data Din, and may supply the output data Dout to the data driver 120. For example, the timing controller 140 may generate the output data Dout by correcting the input data Din to reflect an optical measurement result.

In an embodiment, the timing controller 140 may generate a data driving signal DCS and a scan driving signal SCS in response to a control signal CS. The data driving signal DCS may be supplied to the data driver 120, and the scan driving signal SCS may be supplied to the scan driver 130.

The pixel portion 110 may include pixels PX which are connected to scan lines SL1, SL2, . . . , SLn (n is a natural number of 3 or more), and data lines DL1, DL2, . . . , DLm (m is a natural number of 3 or more).

The data lines DL1 to DLm may extend in a first direction DR1. The first direction DR1 may be, for example, a direction extending from an upper side to a lower side of the pixel portion 110, or a direction extending from a left side to a right side of the pixel portion 110. However, the present disclosure is not limited thereto. For example, the first direction DR1 may be a direction extending in a diagonal direction of the pixel portion 110.

The scan lines SL1 to SLn may extend in a second direction DR2. The second direction DR2 may be a direction orthogonal to the first direction DR1. For example, the second direction DR2 may be a direction extending from the left side to the right side of the pixel portion 110, or a direction extending from the upper side to the lower side of the pixel portion 110.

The plurality of pixels PX may be arranged in the pixel portion 110 and be electrically connected to the data lines DL1 to DLm and the scan lines SL1 to SLn. For example, the pixels PX may be arranged in various ways which are currently known.

The pixels PX connected to the same scan line are selected simultaneously (e.g., the pixels PX connected to the same scan line may be referred to as one horizontal line (or one pixel row)) in response to a scan signal supplied to each of the scan lines SL1 to SLn sequentially, and the pixels PX selected by the scan signal may receive a data signal from a data line (one of DL1 to DLm) connected to the pixels PX. The pixels PX supplied with the data signal may generate light of predetermined luminance corresponding to the data signal.

The data driver 120 may receive the output data Dout and the data driving signal DCS from the timing controller 140. The data driver 120 may generate the data signal based on the data driving signal DCS and the output data Dout. For example, the data driver 120 may generate an analog data signal corresponding to a grayscale of the output data Dout. The data driver 120 may supply the data signal to the pixels in units of one horizontal period.

The scan driver 130 may receive the scan driving signal SCS from the timing controller 140.

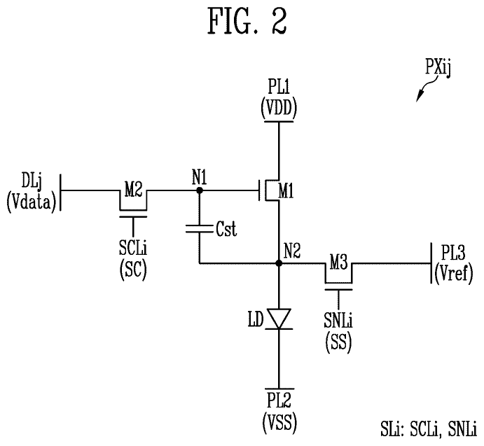

In an embodiment, each of the scan lines SL1 to SLn may include a scan line SCL and an initialization line SNL as shown in FIG. 2. The scan driver 130 may sequentially supply the scan signal to the scan lines SCL in response to the scan driving signal SCS. The scan driver 130 may sequentially supply an initialization signal to the initialization lines SNL in response to the scan driving signal SCS.

In an embodiment of the present disclosure, the display device may be a flat display device, a curved display device in which a part of the pixel portion 110 is bent, a flexible display device in which a part of the pixel portion 110 may be folded or bent, and a stretchable display device in which a part of the pixel portion 110 is stretched and contracted.

In an embodiment of the present disclosure, the display device displays a moving image or a still image. Examples of the display device may include a portable electronic device such as a mobile phone, a smartphone, a tablet personal computer (PC), a smartwatch, a watch phone, a mobile communication terminal, an electronic notebook, an electronic book, a portable multimedia player (PMP), a navigation device, or an ultra-mobile PC (UMPC). Examples of the display device may further include an electronic device such as a television, a notebook computer, a monitor, a billboard, or an Internet of Things (IoT) device.

FIG. 2 is a schematic diagram of an equivalent circuit of the pixel shown in FIG. 1. For convenience of description, FIG. 2 shows a pixel PXij located on an i-th horizontal line (where i is a natural number less than or equal to n and greater than or equal to 1) and a j-th vertical line (where j is a natural number less than or equal to m and greater than or equal to 1).

Referring to FIG. 2, the pixel PXij according to an embodiment of the present disclosure may include a light emitting device LD and a pixel circuit for controlling an amount of current supplied to the light emitting device LD. The i-th scan line SLi may include an i-th scan line SCLi and an i-th initialization line SNLi.

A first electrode (or an anode electrode) of the light emitting device LD may be connected to a first power line PL1 through a second node N2 and a first transistor M1, and a second electrode (or a cathode electrode) may be connected to a second power line PL2. The light emitting device LD as described above may generate light of predetermined luminance in response to an amount of current supplied from the first transistor M1.

The first power line PL1 may provide first driving power VDD, and the second power line PL2 may provide second driving power VSS. During a period in which the pixel PXij emits light, the first driving power VDD may have a higher voltage level than the second driving power VSS.

The light emitting device LD may be an organic light emitting diode. However, the present disclosure is not limited thereto. For example, the light emitting device LD may be an inorganic light emitting diode, such as a micro light emitting diode (LED) or a quantum dot light emitting diode, or a device including a combination of organic and inorganic materials. Although FIG. 2 illustrates that the pixel PX includes a single light emitting device LD, the pixel PX may include a plurality of light emitting devices, which may be connected in series, in parallel, or in a combination of serial-parallel connection.

The pixel circuit may include the first transistor M1, a second transistor M2, a third transistor M3, and a storage capacitor Cst.

A first electrode of the first transistor M1 may be connected to the first power line PL1, and a second electrode may be connected to the second node N2. Here, “being connected” may include a meaning of “being electrically connected.” A gate electrode of the first transistor M1 may be connected to a first node N1. The first transistor M1 may control an amount of current flowing from the first power line PL1 to the second power line PL2 via the light emitting device LD in response to a voltage of the first node N1.

The second transistor M2 may be connected between the j-th data line DLj and the first node N1. A gate electrode of the second transistor M2 may be electrically connected to the i-th scan line SCLi. The second transistor M2 may be turned on when an enable scan signal SC is supplied to the i-th scan line SCLi and may electrically connect the j-th data line DLj to the first node N1. When the second transistor M2 is turned on, the data signal from the j-th data line DLj may be supplied to the first node N1.

The scan signal SC may have a gate-on voltage (e.g., enable) or a gate-off voltage (e.g., disable). The enable scan signal SC may mean that the gate-on voltage is supplied to the i-th scan line SCLi to turn on the transistor connected to the i-th scan line, and the disable scan signal SC may mean that the gate-off voltage is supplied to the i-th scan line SCLi to turn off the transistor connected to the i-th scan line.

The third transistor M3 may be connected between the second node N2 and a third power line PL3. A gate electrode of the third transistor M3 may be electrically connected to the i-th initialization line SNLi. The third transistor M3 may be turned on when an enable initialization signal SS is supplied to the i-th initialization line SNLi and may electrically connect the second node N2 and the third power line PL3. When the third transistor M3 is turned on, a voltage of reference power Vref from the third power line PL3 may be supplied to the second node N2.

The reference power Vref may be supplied to the third power line PL3. The voltage of the reference power Vref may be set to turn off the light emitting device LD when the reference power Vref is supplied to the second node N2. To set the voltage of the reference power Vref as described above, a voltage difference between the reference power Vref and the second driving power VSS may be smaller than a threshold voltage of the light emitting device LD. For example, the voltage of the reference power Vref may be set to be the same as or similar to a voltage of the second driving power VSS.

The initialization signal SS may have a gate-on voltage (e.g., enable) or a gate-off voltage (e.g., disable). The enable initialization signal SS may mean that the gate-on voltage is supplied to the i-th initialization line SNLi to turn on the transistor connected to the i-th initialization line SNLi, and the disable initialization signal SS may mean that the gate-off voltage is supplied to the i-th initialization line SNLi to turn off the transistor connected to the i-th initialization line SNLi.

In FIG. 2, the first to third transistors M1 to M3 are illustrated as N-type transistors, but embodiments of the present disclosure are not limited thereto. For example, at least one of the first to third transistors M1 to M3 may be implemented as a P-type transistor.

The storage capacitor Cst may be connected between the first node N1 and the second node N2. The storage capacitor Cst may store a voltage corresponding to the data signal. For example, the storage capacitor Cst may store a voltage corresponding to a difference between the data signal supplied to the first node N1 and the reference power Vref supplied to the second node N2.

The structure of the pixel PXij according to an embodiment is not limited to the embodiment shown in FIG. 2. For example, the pixel PXij may include additional transistors and/or a capacitor, and may be implemented as including various types of circuits which are currently known.

To briefly explain an driving operation of the pixel PXij, the enable scan signal SC and the enable initialization signal SS may be sequentially supplied to each of the scan lines SL1 to SLn during a driving period. The enable scan signal SC supplied to the i-th scan line SCLi may be provided in synchronization the enable initialization signal SS supplied to the i-th initialization line SNLi.

When the enable initialization signal SS is supplied to the i-th initialization line SNLi, the third transistor M3 is turned on, and the voltage of the reference power Vref may be supplied to the second node N2. When the enable scan signal SC is supplied to the i-th scan line SCLi, the second transistor M2 may be turned on, and the data signal may be supplied to the first node N1. A voltage corresponding to a difference between the data signal and the reference power Vref may be stored in the storage capacitor Cst.

Thereafter, the second transistor M2 may be turned off in response to the disable scan signal SC supplied to the i-th scan line SCLi, and the third transistor M3 may be turned off in response to the disable initialization signal SS supplied to the i-th initialization line SNLi. The first transistor M1 may supply a predetermined current to the light emitting device LD in response to the voltage stored in the storage capacitor Cst, and the light emitting device LD may generate light having luminance corresponding to the current supplied from the first transistor M1.

During a sensing period, the enable scan signal SC and the enable initialization signal SS synchronized with the enable scan signal SC may be supplied to at least one of the scan lines SL1 to SLn. The scan line (for example, at least one of the scan lines SL1 to SLn) to which the enable scan signal SC and the enable initialization signal SS are supplied during the sensing period may be randomly set for each sensing period.

In an embodiment, during the sensing period, the enable initialization signal SS may be supplied to the i-th initialization line SNLi, and the enable scan signal SC may be supplied to the i-th scan line SCLi. When the enable initialization signal SS is supplied to the i-th initialization line SNLi, the third transistor M3 is turned on, and the voltage of the reference power Vref may be supplied to the second node N2.

When the enable scan signal SC is supplied to the i-th scan line SCLi, the second transistor M2 may be turned on, and a preset reference data signal may be supplied to the first node N1. The reference data signal may have a preset voltage to sense the characteristics of the pixels PX may be sensed. A voltage corresponding to a difference between the reference data signal and the reference power Vref may be stored in the storage capacitor Cst.

Thereafter, the second transistor M2 may be turned off in response to the disable scan signal SC supplied to the i-th scan line SCLi. The third transistor M3 is maintained in a turn-on state, and the third power line PL3 may be electrically connected to the timing controller 140 (at this time, the voltage of the reference power Vref is not supplied to the third power line PL3).

Then, a current corresponding to the reference data signal may be supplied from the first transistor M1 to the timing controller 140 via the second node N2 and the third transistor M3, and the timing controller 140 may control the output data Dout to compensate for a threshold voltage of the first transistor M1, the mobility, and/or the degradation of the light emitting device LD, in response to the current (or the voltage) from the second node N2.

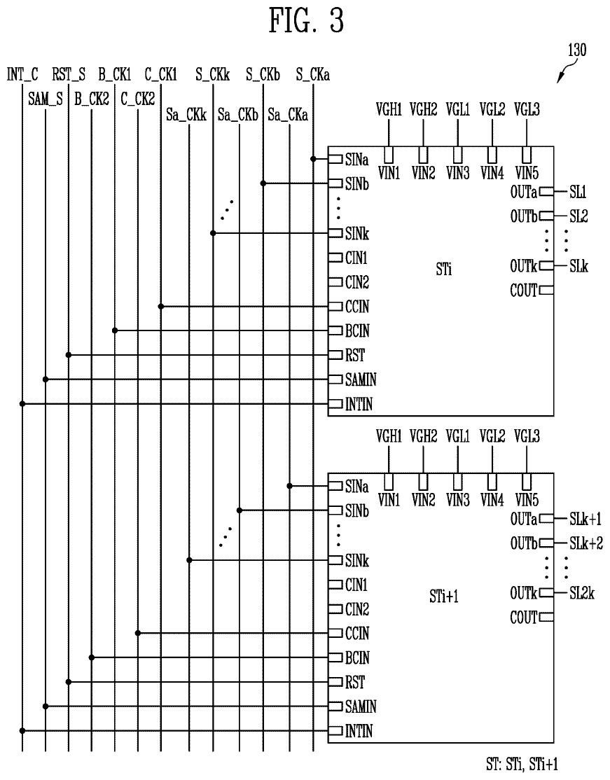

FIG. 3 is a diagram illustrating the scan driver 130 shown in FIG. 1. FIG. 3 illustrate an i-th stage circuit STi and an (i+1)-th stage circuit STi+1 for convenience of description.

Referring to FIG. 3, the scan driver 130 according to an embodiment of the present disclosure may include a plurality of stage circuits ST. Each of the stage circuits STi and STi+1 may be connected to a plurality of scan lines SL1, SL2, . . . , SLk or SLk+1, SLk+2, . . . , SL2k (where k is a natural number of 2 or more). Each of the scan lines SL1 to SLk or SLk+1 to SL2k may include at least one of the scan line SCL or the initialization line SNL shown in FIG. 2.

For example, each of the scan lines SL1 to SLk or SLk+1 to SL2k may be the scan line SCL. For example, each of the scan lines SL1 to SLk or SLk+1 to SL2k may be the initialization line SNL. For example, each of the scan lines SL1 to SLk or SLk+1 to SL2k may include the scan line SCL and the initialization line SNL.

The i-th stage circuit STi is connected to the k scan lines SL1 to SLk, and may supply a scan signal (and/or an initialization signal) to the k scan lines SL1 to the SLk. The (i+1)-th stage circuit STi+1 is connected to the k scan lines SLk+1 to SL2k, and may supply a scan signal (and/or an initialization signal) to the k scan lines SLk+1 to SL2k. That is, in an embodiment of the present disclosure, one stage circuit may provide a plurality of scan lines SL1 to SLk or SLk+1 to SL2k with a plurality of scan signals including a scan signal SC and/or an initialization signal SS, thereby minimizing the mounting area of the scan driver 130.

Each of the stage circuits STi and STi+1 may include power input terminals VIN1, VIN2, VIN3, VIN4, and VIN5, scan clock input terminals SINa, SINb, . . . , SINk, carry input terminals CIN1 and CIN2, a carry clock input terminal CCIN, a boosting clock input terminal BCIN, a reset input terminal RST, a sampling input terminal SAMIN, an initialization terminal INTIN, output terminals OUTa to OUTk, and a carry output terminal COUT.

The first power input terminal VIN1 may receive a voltage of first power VGH1. The first power VGH1 may have a positive voltage, for example, a logic high-level voltage. The logic high-level voltage may refer to a voltage level which turns on a transistor receiving the corresponding voltage. For example, the first power VGH1 may have a voltage of 25 V.

The second power input terminal VIN2 may receive a voltage of second power VGH2. The second power VGH2 may have a positive voltage, for example, a logic high-level voltage or a logic low-level voltage. The logic low-level voltage may refer to a voltage level which turns off a transistor receiving the corresponding voltage. The transistor receiving the second power VGH2 supplied to a gate electrode thereof may be turned on or turned off according to a voltage level of a first electrode (or a second electrode) thereof. In an embodiment, the second power VGH2 has a lower voltage than the first power VGH1, for example, a voltage of 15 V.

The third power input terminal VIN3 may receive a voltage of third power VGL1. The third power VGL1 may have a negative voltage and may have a logic low-level voltage. The third power VGL1 has a lower voltage than the second power VGH2, for example, a voltage of −9 V.

The fourth power input terminal VIN4 may receive a voltage of fourth power VGL2. The fourth power VGL2 may have a negative voltage and may have a logic low-level voltage. The fourth power VGL2 has a lower voltage than the second power VGH2, and has a higher voltage than the third power VGL1, for example, a voltage of −5 V.

The fifth power input terminal VIN5 may receive a voltage of fifth power VGL3. The fifth power VGL3 may have a negative voltage and may have a logic low-level voltage. The fifth power VGL3 may have various voltage levels. For example, the fifth power VGL3 may be set to the same voltage as the fourth power VGL2 (or the third power VGL1), and in this case, the fifth power input terminal VIN5 may be replaced with the fourth power input terminal VIN4 (or the third power input terminal VIN3).

Each of the output terminals OUTa, OUTb, . . . , OUTk may be connected to a scan line (either one of SL1 to SLk or one of SLk+1 to SL2k). The output terminals OUTa, OUTb, . . . , OUTk may output a scan signal SC (or an initialization signal SS) to the scan line (either one of SL1 to SLk or one of SLk+1 to SL2k) connected thereto.

Each of the scan clock input terminals SINa, SINb, . . . , SINk included in an odd-numbered stage circuit (e.g., STi) may receive one of scan clock signals S_CKa, S_CKb, . . . , S_CKk. The scan clock signals S_CKa to S_CKk may be supplied to one of the output terminals OUTa to OUTk in the odd-numbered state circuit (e.g., STi), and the scan clock signals S_CKa to S_CKk supplied to the output terminals OUTa to OUTk may be supplied as an enable scan signal (or an enable initialization signal) to the scan lines SL1 to SLk.

Each of the scan clock input terminals SINa, SINb, . . . , SINk included in an even-numbered stage circuit (e.g., STi+1) may receive one of scan clock signals Sa_CKa, Sa_CKb, . . . , Sa_CKk. The scan clock signals Sa_CKa to Sa_CKk may be supplied to one of the output terminals OUTa to OUTk in the even-numbered stage circuit (e.g., STi+1), and the scan clock signals Sa_CKa to Sa_CKk supplied to the output terminals OUTa to OUTk may be supplied as an enable scan signal (or an enable initialization signal) to the scan lines SLk+1 to SL2k.

In FIG. 3, the scan clock signals S_CKa to S_CKk supplied to the odd-numbered stage circuit (e.g., STi) and the scan clock signals Sa_CKa to Sa_CKk supplied to the even-numbered stage circuit (e.g., STi+1) are shown as different signals, but the present disclosure is not limited thereto. For example, at least one of the scan clock signals S_CKa to S_CKk and Sa_CKa to Sa_CKk supplied to the odd-numbered stage circuit (e.g., STi) and the even-numbered stage circuit (e.g., STi+1) may be shared.

The carry input terminals CIN1 and CIN2 may receive carry signals from a previous stage circuit and a next stage circuit, respectively. For example, the first carry input terminal CIN1 included in the i-th stage circuit STi may receive an (i−1)-th carry signal (e.g., a first carry signal), and the second carry input terminal CIN2 may receive an (i+1)-th carry signal (i.e., a second carry signal).

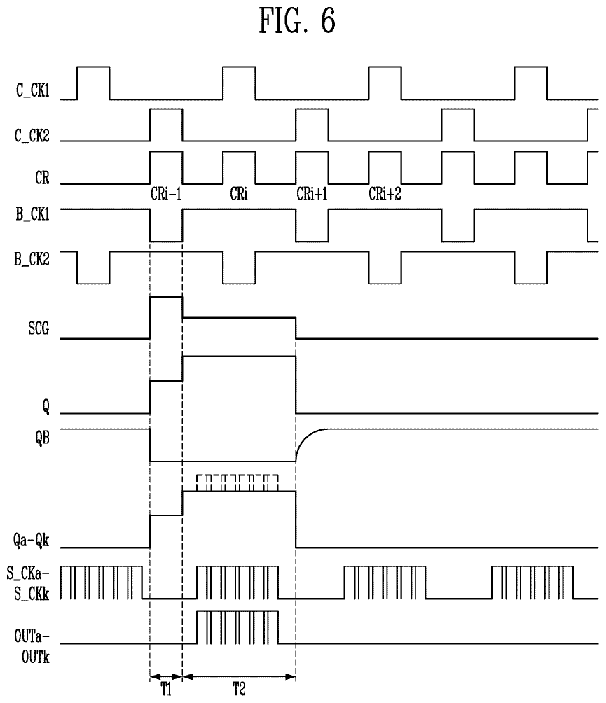

The carry clock input terminal CCIN included in the odd-numbered stage circuit (for example, STi) may receive a first carry clock signal C_CK1, and the carry clock input terminal CCIN included in the even-numbered stage circuit (for example, STi+1) may receive a second carry clock signal C_CK2. As shown in FIG. 6, the first carry clock signal C_CK1 and the second carry clock signal C_CK2 may have the same period but may have different phases. For example, the first carry clock signal C_CK1 and the second carry clock signal C_CK2 may have a phase difference of 180 degrees.

The boosting clock input terminal BCIN included in the odd-numbered stage circuit (for example, STi) may receive a first boosting clock signal B_CK1, and the boosting clock input terminal BCIN included in the even-numbered stage circuit (for example, STi+1) may receive a second boosting clock signal B_CK2. As shown in FIG. 6, the first boosting clock signal B_CK1 and the second boosting clock signal B_CK2 may have the same period but may have different phases. For example, the first boosting clock signal B_CK1 and the second boosting clock signal B_CK2 may have a phase difference of 180 degrees.

The carry output terminal COUT may output a carry signal. The carry output terminal COUT included in the i-th stage circuit STi may output an i-th carry signal to the first carry input terminal CIN1 in the (i+1)-th stage circuit STi+1 and to the second carry input terminal CIN2 in the (i−1)-th stage circuit STi-1. The carry output terminal COUT included in the (i+1)-th stage circuit STi+1 may output an (i+1)-th carry signal to the first carry input terminal CIN1 in the (i+2)-th stage circuit STi+2 (although the STi+2 is not illustrated in FIG. 3, STi+2 has the identical configurations as STi) and to the second carry input terminal CIN2 in the i-th stage circuit STi.

The reset input terminal RST may receive a reset signal RST_S. The reset signal RST_S may be supplied in common to all stage circuits, and may be used to reset the stage circuits.

The sampling input terminal SAMIN may receive a sampling signal SAM_S. The sampling signal SAM_S is supplied during a driving period, and may be a signal which selects a stage circuit (or a scan line and an initialization line) to which the enable scan signal SC and the enable initialization signal SS are to be supplied during the sensing period.

The initialization terminal INTIN may receive an initialization control signal INT_C. The initialization control signal INT_C is supplied during the sensing period, and may be a signal which controls the enable scan signal SC and the enable initialization signal SS to be supplied from the stage circuit selected by the sampling signal SAM_S.

The reset signal RST_S, the sampling signal SAM_S, and the initialization control signal INT_C may be global signals supplied in common to all stage circuits. When the reset signal RST_S, the sampling signal SAM_S, or the initialization control signal INT_C is supplied, all of the stage circuits may receive the reset signal RST_S, the sampling signal SAM_S, or the initialization control signal INT_C.

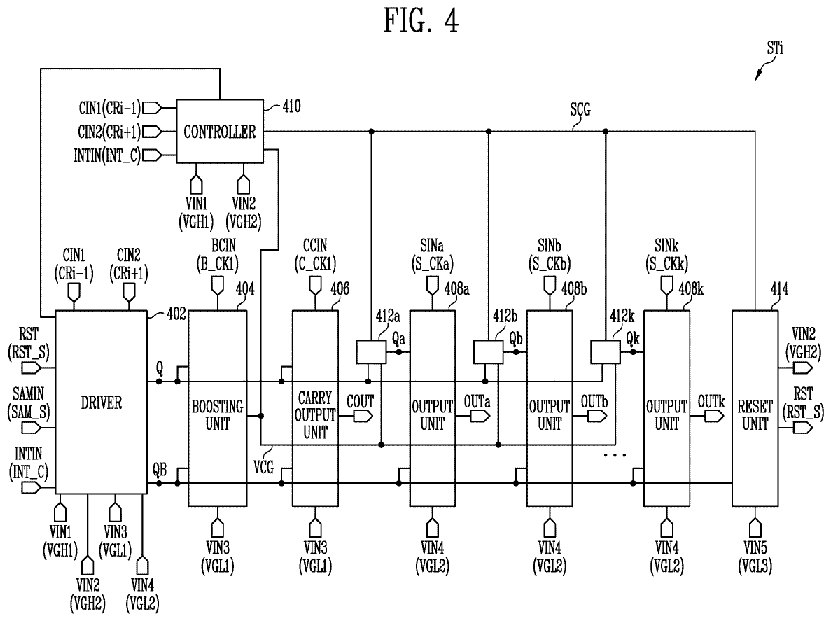

FIG. 4 is a block diagram of a stage circuit according to an embodiment of the present disclosure. FIG. 4 illustrates the i-th stage circuit STi, and the remaining stage circuits may have substantially the same configurations as the i-th stage circuit STi.

Referring to FIG. 4, the stage circuit STi according to an embodiment of the present disclosure may include a driver 402, a boosting unit 404, a carry output unit 406, output units 408a, 408b, . . . , 408k, a controller 410, connecting units 412a, 412b, . . . , 412k, and a reset unit 414.

The driver 402 may be connected to the first power input terminal VIN1, the second power input terminal VIN2, the third power input terminal VIN3, the fourth power input terminal VIN4, the first carry input terminal CIN1, the second carry input terminal CIN2, the reset input terminal RST, the sampling input terminal SAMIN, and the initialization terminal INTIN.

The driver 402 may control voltages of a first node Q and a second node QB. The first node Q may be electrically connected to the boosting unit 404, the carry output unit 406, the output units 408a to 408k through the connecting units 412a to 412k. The second node QB may be electrically connected to the boosting unit 404, the carry output unit 406, the output units 408a to 408k, and the reset unit 414.

The boosting unit 404 may be connected to the boosting clock input terminal BCIN, a third power input terminal VIN3, and a voltage control line VCG. The boosting unit 404 may output a boosting signal to the voltage control line VCG in response to the voltages of the first node Q and the second node QB. The voltage control line VCG may be electrically connected to the connecting units 412a to 412k and the controller 410.

The carry output unit 406 may be connected to the carry clock input terminal CCIN, the third power input terminal VIN3, and the carry output terminal COUT. The carry output unit 406 may output a carry signal to the carry output terminal COUT in response to the voltages of the first node Q and the second node QB.

Each of the output units 408a to 408k may be connected to one of the scan clock input terminals SINa to SINk, one of the output terminals OUTa to OUTk, and the fourth power input terminal VIN4. Each of the output units 408a to 408k may be connected to one of local nodes Qa, Qb, . . . , Qk and the second node QB. The output units 408a to 408k may supply the enable scan signal SC and/or the enable initialization signal SS to the output terminals OUTa to OUTk based on voltages of the local nodes Qa to Qk (or the first node Q).

Each of the connecting units 412a to 412k may be connected between the first node Q and the local nodes Qa to Qk. The connecting units 412a to 412k may electrically connect the first node Q to the local nodes Qa to Qk during a first period T1 (see FIG. 6) when the first node Q has a first level (e.g., a high-level voltage), and electrically disconnect the first node Q from the local nodes Qa to Qk during a second period T2 (see FIG. 6) when the first node Q has a voltage higher than the first level.

The second period T2 may be a period in which the enable scan signal SC and/or the enable initialization signal SS are output from the output units 408a to 408k. The connecting units 412a to 412k may electrically disconnect the first node Q from the local nodes Qa to Qk during the second period when the enable scan signal SC and/or the enable initialization signal SS are output from the output units 408a to 408k, thereby preventing luminance variation on a horizontal line basis.

For example, when the first node Q and the local nodes Qa to Qk are electrically connected to each other during the second period T2, the voltage of the first node Q may be changed. For example, the voltage of the first node Q may be changed based on the supply order of the enable scan signal SC and/or the enable initialization signal SS, and whether the enable scan signal SC and/or the enable initialization signal SS overlap.

When the voltage of the first node Q is changed, the voltages of the local nodes Qa to Qk may be changed. When the voltages of the local nodes Qa to Qk are changed during the second period T2, the enable scan signal SC and/or the enable initialization signal SS having different voltages from the predetermined values of the enable scan signal SC and/or the enable initialization signal SS may be output from the output units 408a to 408k, thereby causing a luminance difference on a horizontal line basis.

In an embodiment of the present disclosure, the connecting units 412a to 412k electrically disconnect the local nodes Qa to Qk from the first node Q during the second period T2 in which the enable scan signal SC and/or the enable initialization signal SS are output, thereby preventing or mitigating a luminance difference on a horizontal line basis.

According to an embodiment, the voltage of the local node Qa to Qk may be changed when the enable scan signal SC or the enable initialization signal SS is output from the output unit 408a to 408k. The amount of voltage change in each of the local nodes Qa to Qk may be substantially the same as each other, and accordingly, the enable scan signal SC and/or the enable initialization signal SS output from the output units 408a to 408k may have substantially the same voltage as each other.

The controller 410 may be connected to the connecting units 412a to 412k via a connection control line SCG. The controller 410 may be connected to the first carry input terminal CIN1, the second carry input terminal CIN2, the initialization terminal INTIN, the first power input terminal VIN1, and the second power input terminal VIN2. The controller 410 may be connected to the driver 402.

The controller 410 may control a voltage of the connection control line SCG in response to carry signals CRi−1 and CRi+1 input through the first and second carry input terminals CIN1 and CIN2. In addition, the controller 410 may control the voltage of the connection control line SCG in response to the initialization control signal INT_C input through the initialization terminal INTIN.

The connecting units 412a to 412k may control the electrical connection between the local nodes Qa to Qk and the first node Q in response to the voltage of the connection control line SCG. For example, the connecting units 412a to 412k may electrically connect the local nodes Qa to Qk to the first node Q when the connection control line SCG has a logic high-level voltage, and electrically disconnect the local nodes Qa to Qk from the first node Q when the connection control line SCG has a logic low-level voltage.

The reset unit 414 may be connected to the connection control line SCG, the second power input terminal VIN2, the fifth power input terminal VIN5, and the reset input terminal RST. The reset unit 414 may control the electrical connection between the connection control line SCG and the fifth power input terminal VIN5 in response to the voltage of the second node QB. The reset unit 414 may control the electrical connection between the connection control line SCG and the second power input terminal VIN2 in response to the reset signal RST_S input through the reset input terminal RST.

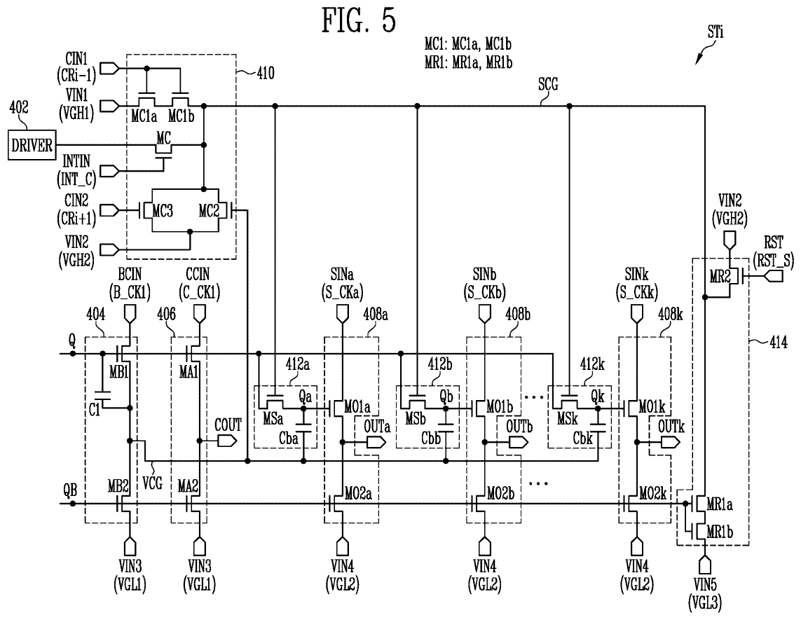

FIG. 5 is a schematic diagram of an equivalent circuit of the controller 410, the boosting unit 404, the carry output unit 406, the output units 408a to 408k, and the connecting units 412a to 412k of the stage circuit STi shown in FIG. 4.

Referring to FIG. 5, the boosting unit 404 may electrically connect the voltage control line VCG to the boosting clock input terminal BCIN or the third power input terminal VIN3 in response to the voltages of the first node Q and the second node QB. It may be described that the boosting signal is output when the first boosting clock signal B_CK1 having a high voltage is supplied to the voltage control line VCG. The boosting signal supplied to the voltage control line VCG may boost the voltages of the first node Q and the local nodes Qa to Qk.

The boosting unit 404 may include a first boosting transistor MB1, a second boosting transistor MB2, and a first capacitor C1.

The first boosting transistor MB1 is connected between the boosting clock input terminal BCIN and the voltage control line VCG, and a gate electrode of the first boosting transistor MB1 may be connected to the first node Q. The first boosting transistor MB1 may control the electrical connection between the boosting clock input terminal BCIN and the voltage control line VCG in response to the voltage of the first node Q.

The second boosting transistor MB2 is connected between the voltage control line VCG and the third power input terminal VIN3, and a gate electrode of the second boosting transistor MB2 may be connected to the second node QB. The second boosting transistor MB2 may control the electrical connection between the voltage control line VCG and the third power input terminal VIN3 in response to the voltage of the second node QB.

The carry output unit 406 may electrically connect the carry output terminal COUT to the carry clock input terminal CCIN or the third power input terminal VIN3 in response to the voltages of the first node Q and the second node QB. It may be described that the carry signal (e.g., the i-th carry signal) is output when the first carry clock signal C_CK1 having a high voltage is output to the carry output terminal COUT.

The carry output unit 406 may include a first carry transistor MA1 and a second carry transistor MA2.

The first carry transistor MA1 is connected between the carry clock input terminal CCIN and the carry output terminal COUT, and a gate electrode of the first carry transistor MA1 may be connected to the first node Q. The first carry transistor MA1 may control the electrical connection between the carry clock input terminal CCIN and the carry output terminal COUT in response to the voltage of the first node Q.

The second carry transistor MA2 is connected between the carry output terminal COUT and the third power input terminal VIN3, and a gate electrode of the second carry transistor MA2 may be connected to the second node QB. The second carry transistor MA2 may control the electrical connection between the carry output terminal COUT and the third power input terminal VIN3 in response to the voltage of the second node QB.

Each of the output units 408a to 408k may be connected to one of the scan clock input terminals SINa to SINk, one of the output terminals OUTa to OUTk, and the fourth power input terminal VIN4. Each of the output units 408a to 408k may include one of first output transistors MO1a, MO1b, . . . , MO1k and one of second output transistors MO2a, MO2b, . . . , MO2k.

A gate electrode of each of the first output transistors MO1a to MO1k may be connected to one of the local nodes Qa to Qk. Gate electrodes of the second output transistors MO2a to MO2k may be electrically connected to the second node QB.

In an embodiment, the output unit 408a may electrically connect the output terminal OUTa to the scan clock input terminal SINa or the fourth power input terminal VIN4 in response to the voltages of the local node Qa and the second node QB. It may be described that the enable scan signal SC or the enable initialization signal SS is output when the scan clock signal S_CKa having a high voltage is supplied to the first output terminal OUTa. The enable scan signal SC or the enable initialization signal SS output from the output terminal OUTa may be supplied to a scan line (e.g., SCL1 (not shown) or SNL1 (not shown)) connected to the output terminal OUTa. The output unit 408a may include the first output transistor MO1a and the second output transistor MO2a.

The first output transistor MO1a is connected between the scan clock input terminal SINa and the output terminal OUTa. The gate electrode of the first output transistor MO1a may be connected to the connecting unit 412a via the local node Qa. The first output transistor MO1a may control the electrical connection between the scan clock input terminal SINa and the output terminal OUTa in response to the voltage of the local node Qa.

The second output transistor MO2a is connected between the output terminal OUTa and the fourth power input terminal VIN4, and the gate electrode of the second output transistor MO2a may be connected to the second node QB. The second output transistor MO2a may control the electrical connection between the output terminal OUTa and the fourth power input terminal VIN4 in response to the voltage of the second node QB.

In an embodiment, the output unit 408b may electrically connect the output terminal OUTb to the scan clock input terminal SINb or the fourth power input terminal VIN4 in response to voltages of the local node Qb and the second node QB. The output unit 408b may include the first output transistor MO1b and the second output transistor MO2b.

The first output transistor MO1b is connected between the scan clock input terminal SINb and the output terminal OUTb. The gate electrode of the first output transistor MO1b may be connected to the connecting unit 412b via the local node Qb. The first output transistor MO1b may control the electrical connection between the scan clock input terminal SINb and the output terminal OUTb in response to the voltage of the local node Qb.

The second output transistor MO2b is connected between the output terminal OUTb and the fourth power input terminal VIN4, and the gate electrode of the second output transistor MO2b may be connected to the second node QB. The second output transistor MO2b may control the electrical connection between the output terminal OUTb and the fourth power input terminal VIN4 in response to the voltage of the second node QB.

In an embodiment, the output unit 408k may electrically connect the output terminal OUTk to the scan clock input terminal SINk or the fourth power input terminal VIN4 in response to the voltages of the local node Qk and the second node QB. The output unit 408k may include the first output transistor MO1k and the second output transistor MO2k.

The first output transistor MO1k is connected between the scan clock input terminal SINk and the output terminal OUTk. The gate electrode of the first output transistor MO1k may be connected to the connecting unit 412k via the local node Qk. The first output transistor MO1k may control the electrical connection between the scan clock input terminal SINk and the output terminal OUTk in response to the voltage of the local node Qk.

The second output transistor MO2k is connected between the output terminal OUTk and the fourth power input terminal VIN4, and the gate electrode of the second output transistor MO2k may be connected to the second node QB. The second output transistor MO2k may control the electrical connection between the output terminal OUTk and the fourth power input terminal VIN4 in response to the voltage of the second node QB.

Each of the connecting units 412a to 412k may be connected between the first node Q and one of the local nodes Qa to Qk. The connecting units 412a to 412k may control the electrical connection between the first node Q and the local nodes Qa to Qk in response to the voltage of the connection control line SCG. Each of the connecting units 412a to 412k may include one of switching transistors MSa, MSb, . . . , MSk and one of boosting capacitors Cba, Cbb, . . . , Cbk.

Each of the switching transistors MSa to MSk may be connected between the first node Q and one of the local nodes Qa to Qk. A gate electrode of each of the switching transistors MSa to MSk may be connected to the connection control line SCG. The switching transistors MSa to MSk may control the electrical connection between the first node Q and the local nodes Qa to Qk in response to the voltage of the connection control line SCG.

Each of the boosting capacitors Cba to Cbk may be connected between the voltage control line VCG and one of the local nodes Qa to Qk. The boosting capacitors Cba to Cbk may control the voltages of the local nodes Qa to Qk in response to a voltage of the voltage control line VCG.

The controller 410 may control the voltage of the connection control line SCG in response to the carry signals CRi−1 and CRi+1 input through the first and second carry input terminals CIN1 and CIN2. In addition, the controller 410 may control the voltage of the connection control line SCG in response to the initialization control signal INT_C input through the initialization terminal INTIN.

The controller 410 may include a control transistor MC, a first control transistor MC1, a second control transistor MC2, and a third control transistor MC3.

The control transistor MC is connected between the driver 402 and the connection control line SCG, and a gate electrode of the control transistor MC may be connected to the initialization terminal INTIN. The control transistor MC is turned on when the initialization control signal INT_C having an enable voltage level is input through the initialization terminal INTIN, and may electrically connect the driver 402 and the connection control line SCG. In the specification, “the enable voltage level” may refer to a voltage level of a corresponding signal which may turn on a transistor connected to the corresponding signal.

The first control transistor MC1 is connected between the first power input terminal VIN1 and the connection control line SCG, and a gate electrode of the first control transistor MC1 may be connected to the first carry input terminal CIN1. The first control transistor MC1 is turned on when the previous-stage carry signal CRi−1 (e.g., the first carry signal CRi−1) having an enable voltage level is input through the first carry input terminal CIN1, and may supply the voltage of the first power VGH1 to the connection control line SCG. The first control transistor MC1 may include a plurality of transistors MC1a and MC1b connected to each other in series, thereby reducing a leakage current.

The second control transistor MC2 is connected between the second power input terminal VIN2 and the connection control line SCG, and a gate electrode of the second control transistor MC2 may be connected to the voltage control line VCG. The second control transistor MC2 may be turned on or turned off in response to the voltage of the voltage control line VCG, and may supply the voltage of the second power VGH2 to the connection control line SCG.

The third control transistor MC3 is connected between the second power input terminal VIN2 and the connection control line SCG, and a gate electrode of the third control transistor MC3 may be connected to the second carry input terminal CIN2. The third control transistor MC3 is turned on when the next-stage carry signal CRi+1 (e.g., the second carry signal CRi+1) having an enable voltage level is input through the second carry input terminal CIN2, and may supply the voltage of the second power VGH2 to the connection control line SCG.

The reset unit 414 may control the electrical connection between the fifth power input terminal VIN5 and the connection control line SCG in response to the voltage of the second node QB. The reset unit 414 may control the electrical connection between the second power input terminal VIN2 and the connection control line SCG in response to the reset signal RST_S input through the reset input terminal RST. The reset unit 414 may include a first reset transistor MR1 and a second reset transistor MR2.

The first reset transistor MR1 is connected between the fifth power input terminal VIN5 and the connection control line SCG, and a gate electrode of the first reset transistor MR1 may be connected to the second node QB. The first reset transistor MR1 may control the electrical connection between the fifth power input terminal VIN5 and the connection control line SCG in response to the voltage of the second node QB. The first reset transistor MR1 may include a plurality of transistors MR1a and MR1b connected to each other in series.

The second reset transistor MR2 is connected between the second power input terminal VIN2 and the connection control line SCG, and a gate electrode of the second reset transistor MR2 may be connected to the reset input terminal RST. The second reset transistor MR2 may be turned on when the reset signal RST_S having an enable voltage level is input through the reset input terminal RST to supply the voltage of the second power VGH2 to the connection control line SCG.

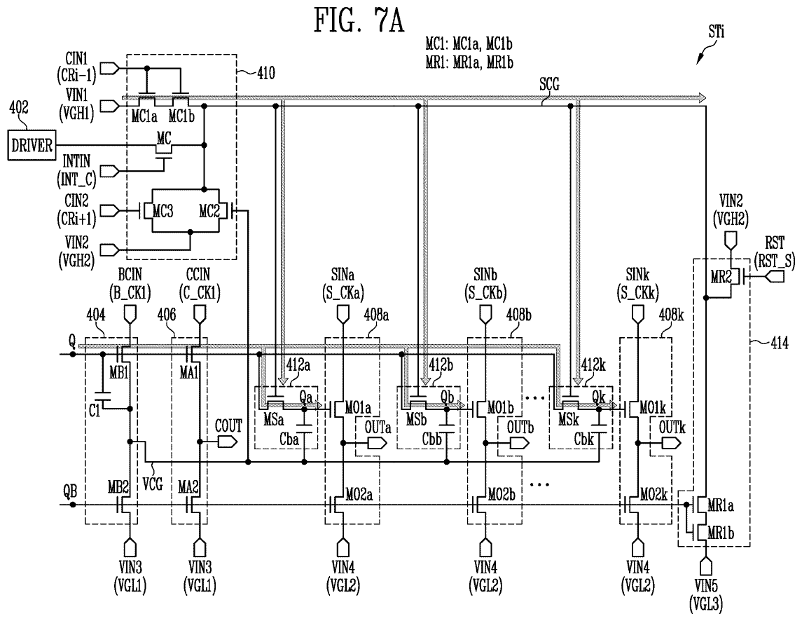

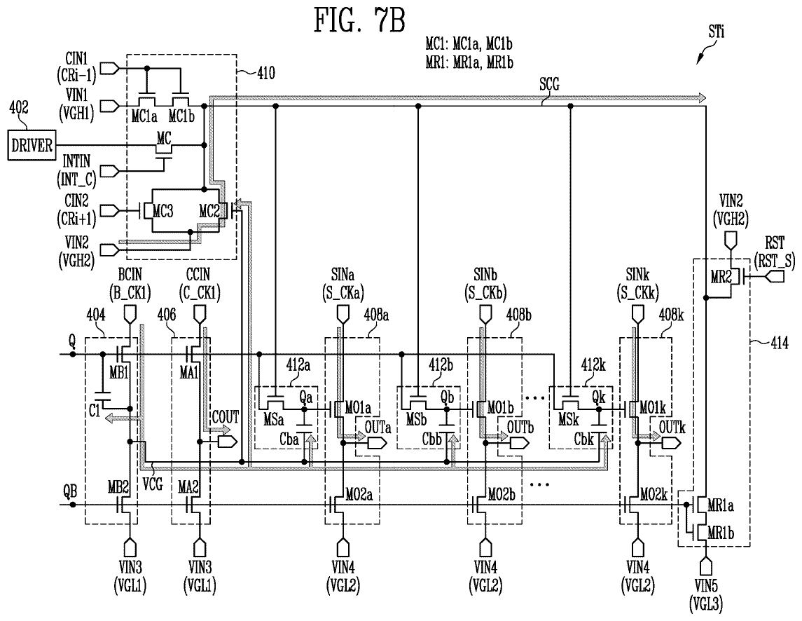

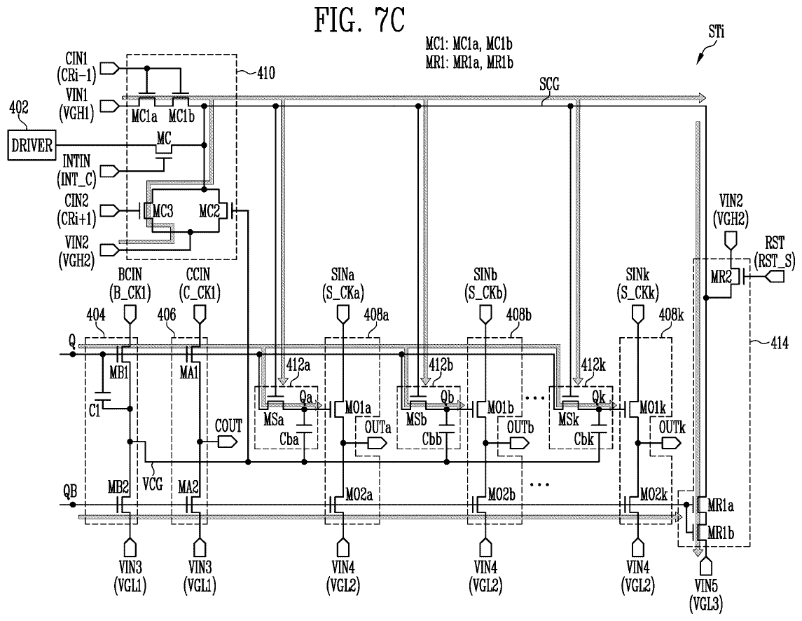

FIG. 6 is a waveform diagram illustrating a method of driving the stage circuit STi shown in FIG. 5. FIGS. 7A to 7C are diagrams illustrating an operation of the stage circuit STi corresponding to the driving waveform of FIG. 6.

The part indicated by S_CKa-S_CKk in FIG. 6 may represent the scan clock signals S_CKa to S_CKk. One or more of the scan clock signals S_CKa to S_CKk may overlap each other, but the present disclosure is not limited thereto. For example, the scan clock signals S_CKa to S_CKk may be supplied so as not to overlap. In addition, some of the scan clock signals S_CKa to S_CKk may be completely overlapped. For example, the scan clock signals which are completely overlapped (at least two of S_CKa to S_CKk) may be supplied as the enable scan signal SC and the enable initialization signal SS to the same horizontal line.

Referring to FIG. 6, the first carry clock signal C_CK1 and the second carry clock signal C_CK2 may have the same period but have a phase difference of 180 degrees. The first boosting clock signal B_CK1 and the second boosting clock signal B_CK2 may have the same period but have a phase difference of 180 degrees. The carry clock signals C_CK1 and C_CK2 and the boosting clock signals B_CK1 and B_CK2 may have the same period.

A high voltage (e.g., a logic high-level voltage) of the carry clock signals C_CK1 and C_CK2 may be supplied for a shorter duration than a low voltage (e.g., a logic low-level voltage) during one period. A low voltage (e.g., a logic low-level voltage) of the boosting clock signals B_CK1 and B_CK2 may be supplied for a shorter duration than a high voltage (e.g., a logic high-level voltage) during one period.

A low voltage of the first boosting clock signal B_CK1 may at least partially overlap a low voltage of the first carry clock signal C_CK1, and a high voltage of the first boosting clock signal B_CK1 may at least partially overlap a high voltage of the first carry clock signal C_CK1. The low voltage of the first boosting clock signal B_CK1 may at least partially overlap a high voltage of the second carry clock signal C_CK2, and the high voltage of the first boosting clock signal B_CK1 may at least partially overlap a low voltage of the second carry clock signal C_CK2.

Carry signals CR including a carry signal in the (i−10-th stage circuit CRi−1, a carry signal in the i-th stage circuit CRi, and etc. may be set to have a high voltage (e.g., a logic high-level voltage), and may be synchronized with the high voltages of the carry clock signals C_CK1 and C_CK2. For example, the stage circuits may output the high voltages of the carry clock signals C_CK1 and C_CK2 as the carry signals CR.

Referring to FIGS. 5 to 7A, the first carry signal CRi−1 (e.g., a logic high level) may be input through the first carry input terminal CIN1 during the first period P1. When the first carry signal CRi−1 is input to the stage circuit STi through the first carry input terminal CIN1, the driver 402 may supply the voltage (e.g., a high voltage) of the first power VGH1 to the first node Q, and the voltage (e.g., a low voltage) of the third power VGL1 to the second node QB. The detailed operation of the driver 402 will be described in detail below.

When the first node Q has the high voltage, the first boosting transistor MB1 and the first carry transistor MA1 may be turned on. When the first boosting transistor MB1 is turned on, the boosting clock input terminal BCIN may be electrically connected to the voltage control line VCG. When the first carry transistor MA1 is turned on, the carry clock input terminal CCIN may be electrically connected to the carry output terminal COUT.

When the first carry signal CRi−1 is input to the stage circuit STi through the first carry input terminal CIN1, the first control transistor MC1 may be turned on. When the first control transistor MC1 is turned on, the voltage of the first power VGH1 may be supplied to the connection control line SCG. When a high voltage (e.g., the voltage of the first power VGH1) is supplied to the connection control line SCG, the switching transistors MSa to MSk may be turned on. When the switching transistors MSa to MSk are turned on, a high voltage at the first node Q may be supplied to the local nodes Qa to Qk. When the high voltage is supplied to the local nodes Qa to Qk, the first output transistors MO1a to MO1k may be turned on.

Referring to FIGS. 5, 6, and 7B, the high-level first carry clock signal C_CK1 may be input to the stage circuit STi through the carry clock input terminal CCIN during the second period P2. The high-level first carry clock signal C_CK1 input through the carry clock input terminal CCIN may be supplied to the carry output terminal COUT via the first carry transistor MA1. The high-level first carry clock signal C_CK1 output to the carry output terminal COUT may be supplied as the i-th carry signal CRi to a next stage circuit and/or a previous stage circuit.

During the second period P2, the high-level first boosting clock signal B_CK1 may be input to the stage circuit STi through the boosting clock input terminal BCIN. The high-level first boosting clock signal B_CK1 may be supplied as a boosting signal to the voltage control line VCG via the first boosting transistor MB1. Therefore, the voltage of the voltage control line VCG may be increased from a low voltage to a high voltage by the boosting signal.

When the voltage of the voltage control line VCG is increased by the boosting signal, the voltage of the first node Q may be boosted by the first capacitor C1. For example, the voltage of the first node Q may be boosted to a voltage approximately twice as high as that of the first power VGH1.

When the voltage of the voltage control line VCG is increased by the boosting signal, the voltages of the local nodes Qa to Qk may be boosted by the boosting capacitors Cba to Cbk. For example, the voltage of the local nodes Qa to Qk may be boosted to a voltage approximately twice as high as that of the first power VGH1. When the voltages of the local nodes Qa to Qk are boosted to a voltage higher than that of the first power VGH1, the first output transistors MO1a to MO1k may be stably stayed in a turn-on state during the second period P2.

When the voltage of the voltage control line VCG is boosted by the boosting signal, the second control transistor MC2 may be turned on. When the second control transistor MC2 is turned on, the voltage of the second power VGH2 may be supplied to the connection control line SCG. The voltage of the second power VGH2 supplied to the connection control line SCG may be supplied to the gate electrodes of the switching transistors MSa to MSk.

A first electrode and a second electrode of each of the switching transistors MSa to MSk are set to a higher voltage than the first power VGH1. Therefore, when the voltage of the second power VGH2 lower than that of the first power VGH1 is supplied to the gate electrodes of the switching transistors MSa to MSk, the switching transistors MSa to MSk may be stayed in a turn-off state.

The high-level scan clock signals S_CKa to S_CKk may be input through the scan clock input terminals SINa to SINk during the second period P2. Because the first output transistors MO1a to MO1k are stayed in the turn-on state, the high-level scan clock signals S_CKa to S_CKk may be supplied as the enable scan signal SC and/or the enable initialization signal SS to the output terminals OUTa to OUTk.

During the second period P2 in which the enable scan signal SC and/or the enable initialization signal SS are output to the output terminals OUTa to OUTk, the switching transistors MSa to MSk are stayed in a turn-off state, thereby enabling the display of an image having uniform luminance in the pixel portion 110.

In other words, if the switching transistors MSa to MSk are not included in each connecting unit 412a to 412k, the voltages of the first node Q and the local nodes Qa to Qk may be changed by parasitic capacitors of the first output transistors MO1a to MO1k during the second period P2. In particular, the voltage of the first node Q may be changed in response to the supply order of the enable scan signal SC and/or the enable initialization signal SS, thereby causing a luminance difference on a horizontal line basis.

On the other hand, when the local nodes Qa to Qk are electrically disconnected from the first node Q by the switching transistors MSa to MSk as in the embodiment of the present disclosure, the first node Q may maintain a constant voltage. In addition, as the local nodes Qa to Qk may have substantially the same voltage as each other after the change in voltage caused by the output of the enable scan signal SC or the enable initialization signal SS, a luminance difference on a horizontal line basis may be prevented from occurring.

In an embodiment of the present disclosure, the switching transistors MSa to MSk may be turned off by using the voltage of the second power VGH2, which is a positive voltage, during the second period P2. Accordingly, a Vgs voltage difference of each of the switching transistors MSa to MSk may be kept low, thereby ensuring the driving stability and minimizing the stress of the switching transistors MSa to MSk.

Referring to FIGS. 5, 6, and 7C, the second carry signal CRi+1 may be input to the stage circuit STi through the second carry input terminal CIN2 after the second period P2. When the second carry signal CRi+1 is input through the second carry input terminal CIN2, the voltage of the third power VGL1 (or a low voltage) may be supplied to the first node Q, and the voltage of the second power VGH2 (or a high voltage) may be supplied to the second node QB. The voltage of the second node QB may be increased to a high voltage by an inverter unit INV included in the driver 402. In this case, the voltage of the second node QB may be gradually increased to the high voltage due to a load of circuit elements connected to the second node QB.

When the second carry signal CRi+1 is input through the second carry input terminal CIN2, the third control transistor MC3 may be turned on. When the third control transistor MC3 is turned on, the voltage of the second power VGH2 may be supplied to the connection control line SCG. Because the voltage of the first node Q is set to the voltage of the third power VGL1, the switching transistors MSa to MSk may be turned on. When the switching transistors MSa to MSk are turned on, the local nodes Qa to Qk may have a low voltage.

Because the voltage of the second node QB is gradually increased to the high voltage, the first reset transistor MR1 may be turned on after the voltages of the local nodes Qa to Qk are set to the low voltage. When the first reset transistor MR1 is turned on, the voltage of the fifth power VGL3 may be supplied to the connection control line SCG. When the voltage of the fifth power VGL3 is supplied to the connection control line SCG, the switching transistors MSa to MSk may be turned off.

The stage circuit STi according to an embodiment of the present disclosure described above may be driven by receiving the previous-stage carry signal as the first carry signal CRi−1 and the next-stage carry signal as the second carry signal CRi+1. When the next-stage carry signal is the (i+1)-th carry signal CRi+1, the addition of unnecessary dummy stage circuits may be minimized or reduced.

More specifically, when an (i+2)-th carry signal or one of subsequent carry signals is used as the next-stage carry signal, dummy stage circuits should be additionally formed. In addition, it may be difficult to secure the sensing period when the (i+2)-th carry signal is used as the next-stage carry signal.

The stage circuit STi according to an embodiment of the present disclosure may control the connecting units 412a to 412k and the output units 408a to 408k by using the voltages of the first node Q and the second node QB, thereby minimizing or reducing the mounting area of the stage circuit STi.

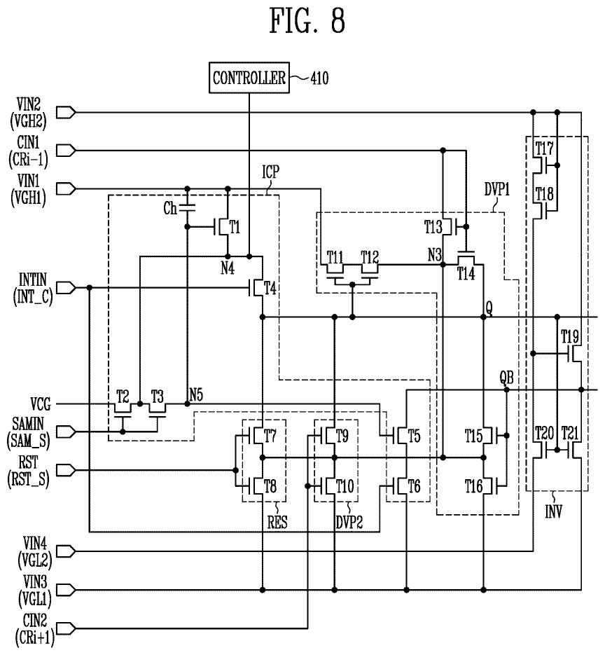

FIG. 8 is a diagram illustrating the driver 402 of the stage circuit STi shown in FIG. 4.

Referring to FIG. 8, the driver 402 according to an embodiment of the present disclosure may include an initialization controller ICP, a reset unit RES, a first driver DVP1, a second driver DVP2, and the inverter unit INV.

The inverter unit INV may control the voltage of the second node QB in response to the voltage of the first node Q. For example, when the voltage of the first node Q is a high voltage (or a low voltage), the inverter unit INV may set the voltage of the second node QB to a low voltage (or a high voltage).

To set the voltage of the second node QB, the inverter unit INV may include a 17th transistor T17, an 18th transistor T18, a 19th transistor T19, a 20th transistor T20, and a 21st transistor T21.

The 17th transistor T17 and the 18th transistor T18 may be connected in series between the second power input terminal VIN2 and a gate electrode of the 19th transistor T19. Gate electrodes of the 17th transistor T17 and the 18th transistor T18 may be connected to the second power input terminal VIN2. The 17th transistor T17 and the 18th transistor T18 may be connected in the form of diodes to allow a current to flow from the second power input terminal VIN2 to the gate electrode of the 19th transistor T19.

The 20th transistor T20 may be connected between the gate electrode of the 19th transistor T19 and the fourth power input terminal VIN4. A gate electrode of the 20th transistor T20 may be connected to the first node Q.

The 21st transistor T21 may be connected between the second node QB and the third power input terminal VIN3. A gate electrode of the 21st transistor T21 may be connected to the first node Q.

The 19th transistor T19 may be connected between the second power input terminal VIN2 and the second node QB. The gate electrode of the 19th transistor T19 may be connected to a common node between the 18th transistor T18 and the 20th transistor T20.

The first driver DVP1 may supply a high voltage to the first node Q when the first carry signal CRi−1 is input from the first carry input terminal CIN1. To supply the high voltage to the first node Q, the first driver DVP1 may include an 11th transistor T11, a 12th transistor T12, a 13th transistor T13, a 14th transistor T14, a 15th transistor T15, and a 16th transistor T16.

The 11th transistor T11 and the 12th transistor T12 may be connected in series between the first power input terminal VIN1 and a third node N3. Gate electrodes of the 11th transistor T11 and the 12th transistor T12 may be connected to the first node Q. The 11th transistor T11 and the 12th transistor T12 may be turned on or turned off in response to the voltage of the first node Q and may control the electrical connection between the first power input terminal VIN1 and the third node N3.

The 13th transistor T13 may be connected between the first carry input terminal CIN1 and the third node N3. A gate electrode of the 13th transistor T13 may be connected to the first carry input terminal CIN1. The 13th transistor T13 may be connected in the form of a diode to allow a current to flow from the first carry input terminal CIN1 to the third node N3.

The 14th transistor T14 may be connected between the third node N3 and the first node Q. A gate electrode of the 14th transistor T14 may be connected to the first carry input terminal CIN1.

The 15th transistor T15 may be connected between the first node Q and the third node N3. A gate electrode of the 15th transistor T15 may be connected to the second node QB.

The 16th transistor T16 may be connected between the third node N3 and the third power input terminal VIN3. A gate electrode of the 16th transistor T16 may be connected to the second node QB.

The second driver DVP2 may control the voltage of the first node Q in response to the second carry signal CRi+1 input through the second carry input terminal CIN2. To control the voltage of the first node Q, the second driver DVP2 may include a ninth transistor T9 and a 10th transistor T10.

The ninth transistor T9 may be connected between the first node Q and the third node N3. A gate electrode of the ninth transistor T9 may be connected to the second carry input terminal CIN2.

The 10th transistor T10 may be connected between the third node N3 and the third power input terminal VIN3. A gate electrode of the 10th transistor T10 may be connected to the second carry input terminal CIN2.

The reset unit RES may control the voltage of the first node Q in response to the reset signal RST_S input through the reset input terminal RST. To control the voltage of the first node Q, the reset unit RES may include a seventh transistor T7 and an eighth transistor T8.

The seventh transistor T7 may be connected between the first node Q and the third node N3. A gate electrode of the seventh transistor T7 may be connected to the reset input terminal RST.

The eighth transistor T8 may be connected between the third node N3 and the third power input terminal VIN3. A gate electrode of the eighth transistor T8 may be connected to the reset input terminal RST.

The seventh transistor T7 and the eighth transistor T8 may be turned on when the reset signal RST_S is input, and may supply the voltage of the third power VGL1 to the first node Q when the seventh and eight transistors T7 and T8 are turned on.

The initialization controller ICP may control, in response to the sampling signal SAM_S input through the sampling input terminal SAMIN and the initialization control signal INT_C input through the initialization terminal INTIN, to supply the enable scan signal SC to a scan line connected to a specific pixel row (or a specific horizontal line) and the enable initialization signal SS to an initialization line connected to the specific pixel row (or the specific horizontal line) during the sensing period. To this end, the initialization controller ICP may include a first transistor T1, a second transistor T2, a third transistor T3, a fourth transistor T4, a fifth transistor T5, and a sixth transistor T6.

The first transistor T1 may be connected between the first power input terminal VIN1 and a fourth node N4. A gate electrode of the first transistor T1 may be connected to a fifth node N5.

The fourth node N4 may be electrically connected to the controller 410. In an embodiment, the fourth node N4 may be electrically connected to the control transistor MC illustrated in FIG. 5. The control transistor MC of the controller 410 may be connected between the fourth node N4 and the connection control line SCG.

The second transistor T2 and the third transistor T3 may be connected in series between the voltage control line VCG and the fifth node N5. Gate electrodes of the second transistor T2 and the third transistor T3 may be connected to the sampling input terminal SAMIN. A common node between the second transistor T2 and the third transistor T3 may be connected to the fourth node N4.

The fourth transistor T4 may be connected between the fourth node N4 and the first node Q. A gate electrode of the fourth transistor T4 may be connected to the initialization terminal INTIN.

The fifth transistor T5 and the sixth transistor T6 may be connected in series between the second node QB and the third power input terminal VIN3. A gate electrode of the fifth transistor T5 may be connected to the fifth node N5, and a gate electrode of the sixth transistor T6 may be connected to the initialization terminal INTIN.

A holding capacitor Ch may be connected between the first power input terminal VIN1 and the fifth node N5. The holding capacitor Ch may store a voltage of the fifth node N5.

However, the configuration of the driver 402 according to an embodiment of the present disclosure is not limited to the driver 402 illustrated in FIG. 8, and the configuration of the driver 402 may include various circuits which are currently known. For example, the driver 402 may include various currently known circuits capable of controlling the first node Q and the second node QB.

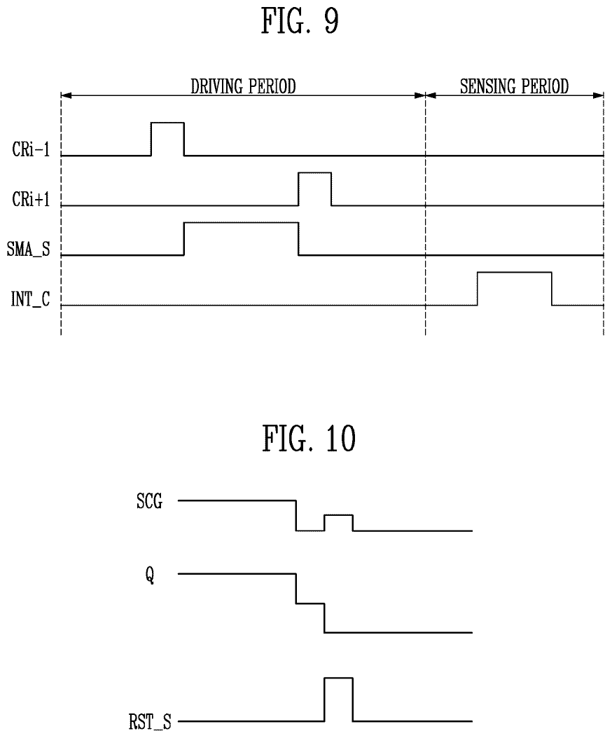

FIG. 9 is a waveform diagram illustrating an operation of the driver 402 shown in FIG. 8. In describing FIG. 9, the part described with reference to FIG. 6 will be omitted or briefly described.

Referring to FIG. 9, the first carry signal CRi−1 may be input to the first carry input terminal CIN1 during a driving period.

When the first carry signal CRi−1 having an enable voltage level is input, the 13th transistor T13 and the 14th transistor T14 are turned on, and accordingly, the voltage of the first node Q may be increased to a high voltage. When the voltage of the first node Q has the high voltage, the 11th transistor T11 and the 12th transistor T12 are turned on, and the voltage of the first power VGH1 may be supplied to the third node N3. The third node N3 is electrically connected to the first node Q via the 14th transistor T14, and accordingly, the first node Q may have approximately the same voltage as the voltage of the first power VGH1.

When the first node Q has the high voltage, the 20th transistor T20 and the 21st transistor T21 may be turned on. When the 20th transistor T20 is turned on, the voltage of the fourth power VGL2 is supplied to the gate electrode of the 19th transistor T19, and accordingly, the 19th transistor T19 is turned off. When the 21st transistor T21 is turned on, the voltage of the third power VGL1 is supplied to the second node QB, and accordingly, the second node QB may have a low voltage.

The sampling signal SAM_S may be input to the driver 402 through the sampling input terminal SAMIN during the driving period. For example, the sampling signal SAM_S may be supplied to every stage circuit in common when the enable scan signal SC and/or the enable initialization signal SS are output from a specific stage circuit. When the sampling signal SAM_S having an enable voltage level is supplied, the second transistor T2 and the third transistor T3 included in the specific stage circuit may be turned on.

When the second transistor T2 and the third transistor T3 are turned on, the voltage control line VCG and the fifth node N5 may be electrically connected. When the voltage (or a boosting signal) of the voltage control line VCG, which has a high voltage, is supplied to the fifth node N5, the high voltage of the voltage control line VCG may turn on the first transistor T1, and be stored in the holding capacitor Ch.

When the sampling signal SAM_S is supplied to every stage circuit in common, the second transistor T2 and the third transistor T3 not included in the specific stage circuit (that is, the second transistor T2 and the third transistor T3 included in the remaining stage circuits except for the specific stage circuit) may also be turned on.

When the second transistor T2 and the third transistor T3 are turned on, the voltage control line VCG and the fifth node N5 which are included in each of the remaining stage circuits may be electrically connected. As the boosting signal is not supplied to the voltage control line VCG included in each of the remaining stage circuits, the voltage of the fifth node N5 in each of the remaining stage circuits is unable to turn on the first transistor T1 and the fifth transistor T5 connected to the fifth node N5, and the voltage of the fifth node N5 is stored in the holding capacitor Ch included in each of the remaining stage circuits.

Thereafter, the second carry signal CRi+1 having an enable voltage level may be input to the second carry input terminal CIN2. When the second carry signal CRi+1 having the enable voltage level is input, the ninth transistor T9 and the 10th transistor T10 may be turned on. When the ninth transistor T9 and the 10th transistor T10 are turned on, the voltage of the third power VGL1 may be supplied to the first node Q. Then, the first node Q may be set to a low voltage.

When the first node Q is set to the low voltage, the 20th transistor T20 and the 21st transistor T21 may be turned off. As a voltage of the gate electrode of the 19th transistor T19 is increased to be approximately the same as the voltage of the second power VGH2 by the 17th transistor T17 and the 18th transistor T18 connected in the form of diodes, the 19th transistor T19 may be turned on. When the 19th transistor T19 is turned on, the voltage (i.e., a high voltage) of the second power VGH2 may be supplied to the second node QB.

When the voltage of the second node QB is set to the high voltage, the 15th transistor T15 and the 16th transistor T16 may be turned on. When the 15th transistor T15 and the 16th transistor T16 are turned on, the voltage of the third power VGL1 is supplied to the first node Q, and accordingly, the voltage of the first node Q may be decreased to the low voltage.

During a sensing period, the initialization control signal INT_C having an enable voltage level may be input to the driver 402 through the initialization terminal INTIN. When the initialization control signal INT_C having the enable voltage level is input through the initialization terminal INTIN, the fourth transistor T4 and the sixth transistor T6 included in every stage circuit may be turned on.

As the holding capacitor Ch in each of the remaining stage circuits stores the voltage of the fifth node N5 which is unable to turn on the transistor connected to the fifth node N5, the first transistor T1 and the fifth transistor T5 included in each of the remaining stage circuits may remain in the turn-off state. Accordingly, the first node Q may maintain the low voltage, and the second node QB may maintain the high voltage.

In contrast, as the holding capacitor Ch in the specific stage circuit, from which the enable scan signal SC and/or the enable initialization signal SS are output, stores the turn-on voltage, the first transistor T1 and the fifth transistor T5 included in the specific stage circuit may be turned on. Because the fourth transistor T4 is in the turn-on state, the voltage of the first power VGH1 may be supplied to the first node Q via the first transistor T1 and the fourth transistor T4. In addition, because the sixth transistor T6 is in the turn-on state, the voltage of the third power VGL1 may be supplied to the second node QB via the sixth transistor T6 and the fifth transistor T5.

When the initialization control signal INT_C is input through the initialization terminal INTIN, the control transistor MC included in the controller 410 may be turned on. When the control transistor MC is turned on, the connection control line SCG may be electrically connected to the fourth node N4. As the fourth node N4 included in the specific stage circuit has the high voltage, the switching transistors MSa to MSk included in the specific stage circuit may be turned on.

When the switching transistors MSa to MSk are turned on, the local nodes Qa to Qk and the first node Q may be electrically connected. Thereafter, as described with reference to FIG. 6, the boosting signal may be supplied to the voltage control line VCG by the first boosting clock signal B_CK1. In addition, by supplying at least one of the scan clock signals S_CKa to S_CKk to the specific stage circuit, the enable scan signal SC may be supplied to a specific horizontal line and the enable initialization signal SS may be supplied to the specific horizontal line during the sensing period. The process of supplying the enable scan signal SC and/or the enable initialization signal SS at the specific stage circuit is the same as described with reference to FIG. 6, and thus a detailed description thereof will be omitted.

FIG. 10 is a diagram illustrating the reset signal RST_S supplied during the sensing period.

Referring to FIG. 10, during the period in which the enable scan signal SC and/or the enable initialization signal SS are supplied to a specific horizontal line, the connection control line SCG and the first node Q included in the specific stage circuit may maintain a high voltage. In addition, when the supply of the first boosting clock signal B_CK1 to the voltage control line VCG is stopped, the voltage of the connection control line SCG and the first node Q may be lowered.

Then, when the reset signal RST_S is input to the reset input terminal RST, the seventh transistor T7, the eighth transistor T8, and the second reset transistor MR2 may be turned on.

When the seventh transistor T7 and the eighth transistor T8 are turned on, the voltage of the third power VGL1 may be supplied to the first node Q. When the second reset transistor MR2 is turned on, the voltage of the second power VGH2 may be supplied to the connection control line SCG. When the voltage of the second power VGH2 is supplied to the connection control line SCG, the switching transistors MSa to MSk may be turned on. Then, the voltages of the local nodes Qa to Qk included in the specific stage circuit may be decreased to have a low voltage of the first node Q.

In the embodiment of the present disclosure, the voltages of the local nodes Qa to Qk can be rapidly decreased to a low voltage by supplying the reset signal RST_S through the reset input terminal RST after the enable scan signal SC and/or the enable initialization signal SS are supplied during the sensing period. Accordingly, the operational reliability of the stage circuit may be ensured.

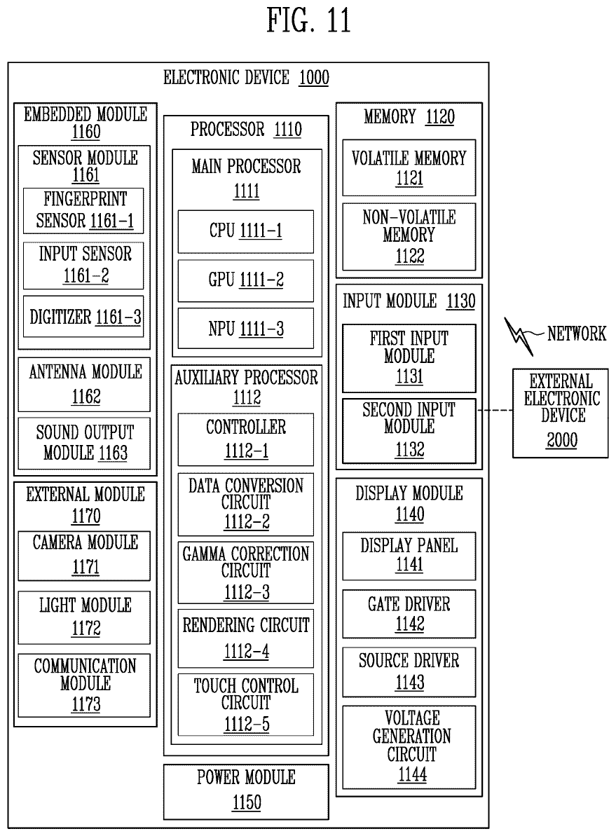

FIG. 11 is a diagram illustrating an electronic device 1000 according to an embodiment of the present disclosure.

Referring to FIG. 11, the electronic device 1000 according to an embodiment of the present disclosure may display various information through a display module 1140. When a processor 1110 executes an application stored in memory 1120, the display module 1140 provides application information to a user through a display panel 1141.

The processor 1110 receives input through an input module 1130 or a sensor module 1161 from external devices, and executes an application corresponding to the received input. For example, when the user selects a camera icon or a camera application icon displayed on the display panel 1141, the processor 1110 receives the user input through an input sensor 1161-2 and activates a camera module 1171. The processor 1110 transmits image data corresponding to a captured image acquired through the camera module 1171 to the display module 1140. The display module 1140 may display an image corresponding to the captured image through the display panel 1141.

The electronic device 1000 may also execute a personal information authentication through the display module 1140. For example, a fingerprint sensor 1161-1 disposed on the display module 1140 acquires fingerprint information as input data. The processor 1110 compares the input data acquired through the fingerprint sensor 1161-1 with the authentication data stored in the memory 1120, and executes an application according to the comparison result. The display module 1140 may display information executed according to the logic of the application through the display panel 1141. The fingerprint sensor 1161-1 may be arranged to acquire fingerprint information in the entire area of the display module 1140 (or the display panel 1141).

The electronic device 1000 may also execute music streaming when a music streaming icon displayed on the display module 1140 is selected. The processor 1110 acquires the user input through the input sensor 1161-2 and activates a music streaming application stored in the memory 1120. When a music play command is input to the music streaming application, the processor 1110 activates a sound output module 1163 to provide sound information corresponding to the music play command to the user.

Operations of the electronic device 1000 have been briefly described above. Components of the electronic device 1000 will be described in detail below. Some components of the electronic device 1000 described below may be integrated and provided as a single component, or one component may be separated and provided as two or more separate components.

The electronic device 1000 may communicate with an external electronic device 2000 through a network such as near field communication network or a far field communication network. According to an embodiment, the electronic device 1000 may include the processor 1110, the memory 1120, the input module 1130, the display module 1140, a power module 1150, an embedded module 1160, and an external module 1170. Some components of the electronic device 1000 may be optional, while other components not listed above may be adopted. Some components such as the sensor module 1161, an antenna module 1162, or the sound output module 1163 may be integrated into another component such as the display module 1140.

The processor 1110 may execute software to control at least one other component (e.g., a hardware or software component) of the electronic device 1000 which is connected to the processor 1110, and may perform various data processing or operations on the hardware or software component. According to an embodiment, as at least a portion of the data processing or operations, the processor 1110 may store commands or data received from another component such as the input module 1130, the sensor module 1161, or a communication module 1173 in volatile memory 1121, process the commands or data stored in the volatile memory 1211, and store the result data of the processing or computation in non-volatile memory 1122.

The processor 1110 may include a main processor 1111 and an auxiliary processor 1112. The main processor 1111 may include a central processing unit (CPU) 1111-1. The main processor 1111 may further include one or more of a graphics processing unit (GPU) 1111-2, a communication processor (CP), or an image signal processor (ISP). The main processor 1111 may further include a neural processing unit (NPU) 1111-3. The NPU 1111-3 is a processor specialized in processing an artificial intelligence model, and the artificial intelligence model may be generated through machine learning. The artificial intelligence model may include a plurality of artificial neural network layers. An artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-networks, or a combination of two or more of the above, but the type of the artificial neural network is not limited to the above-described examples. The artificial intelligence model may include a software structure in addition to or in place of a hardware structure. Two or more of the foregoing processing units and processors may be implemented in one integrated component (e.g., a single chip), or each of the processing units and the processors may be implemented in an independent component (e.g., a plurality of chips).

The auxiliary processor 1112 may include a controller 1112-1. The controller 1112-1 may include an interface conversion circuit and a timing control circuit. For example, the auxiliary processor 1112 may include the timing controller 140 shown in FIG. 1. At least some functions or configurations of the timing controller 140 may be included in the controller 1112-1, a data conversion circuit 1112-2, a gamma correction circuit 1112-3, a rendering circuit 1112-4, and the like.

The controller 1112-1 receives an image signal from the main processor 1111, converts a data format of the image signal in compliance with an interface specification of the display module 1140, and outputs the image data. The controller 1112-1 may output various control signals required for driving the display module 1140.

The auxiliary processor 1112 may further include the data conversion circuit 1112-2, the gamma correction circuit 1112-3, the rendering circuit 1112-4, a touch control circuit 1112-5, and the like. The data conversion circuit 1112-2 may receive image data from the controller 1112-1, and compensate for the image data so that an image is displayed at desired luminance reflecting the characteristics of the electronic device 1000 or the user's settings, or convert the image data to reduce power consumption or to compensate for afterimages.

The gamma correction circuit 1112-3 may convert image data, a gamma reference voltage, or the like so that an image displayed on the electronic device 1000 has a desired gamma characteristic. The rendering circuit 1112-4 may receive the image data from the controller 1112-1 and render the image data in consideration of pixel arrangements or the like in the display panel 1141 applied to the electronic device 1000.

The touch control circuit 1112-5 may supply a touch signal to the input sensor 1161-2 and receive a sensing signal from the input sensor 1161-2 in response to the touch signal.

At least one of the data conversion circuit 1112-2, the gamma correction circuit 1112-3, the rendering circuit 1112-4, or the touch control circuit 1112-5 may be integrated into another component such as the main processor 1111 or the controller 1112-1. At least one of the data conversion circuit 1112-2, the gamma correction circuit 1112-3, or the rendering circuit 1112-4 may be integrated into a source driver 1143 to be described below.

The memory 1120 may store various data used by at least one component of the electronic device 1000, and input data or output data corresponding to various commands. At least one component of the electronic device 1000 may include the processor 1110 or the sensor module 1161. In addition, various user setting may be stored in the memory 1120. The memory 1120 may include at least one of the volatile memory 1121 or the non-volatile memory 1122.

The input module 1130 may receive commands or data from the external electronic device 2000 or other user interface, and provide another component of the electronic device 1000 with the received command or data. The component of the electronic device 1000 may include the processor 1110, the sensor module 1161, or the sound output module 1163.

The input module 1130 may include a first input module 1131 to which the user enters commands or data, and a second input module 1132 to which the external electronic device 2000 provides commands or data. The first input module 1131 may include a microphone, a mouse, a keyboard, a key such as a button, or a pen such as a passive pen or an active pen. The second input module 1132 may support a specified protocol which may be connected in a wired or a wireless manner to the external electronic device 2000. The second input module 1132 may include a high definition multimedia interface (HDMI), a universal serial bus (USB) interface, a secure digital (SD) card interface, or an audio interface. The second input module 1132 may include a connector which may be physically connected to the external electronic device 2000, for example, an HDMI connector, a USB connector, an SD card connector, or an audio connector such as a headphone connector.

The display module 1140 provides visual information to the user. The display module 1140 may include the display panel 1141, a gate driver 1142, the source driver 1143, and a voltage generation circuit 1144. The display module 1140 may include a window, a chassis, and a bracket for protecting the display panel 1141. The display module 1140 may include at least some components of the display device shown in FIG. 1.

The display panel 1141 (or a display) may include a liquid crystal display panel, an organic light-emitting display panel, or an inorganic light-emitting display panel. A type of the display panel 1141 is not particularly limited. The display panel 1141 may be of a rigid type or of a flexible type that is rollable or foldable. The display module 1140 may further include a supporter, a bracket, a heat dissipation layer, or the like supporting the display panel 1141. The display panel 1141 may include the pixel portion 110 shown in FIG. 1.

The gate driver 1142 may be mounted on the display panel 1141 as a driving chip. In addition, the gate driver 1142 may be integrated into the display panel 1141. For example, the gate driver 1142 may include an amorphous silicon TFT gate driver circuit (ASG), a low-temperature polycrystalline silicon (LTPS) TFT gate driver circuit, or an oxide semiconductor TFT gate driver circuit (OSG) embedded in the display panel 1141. The gate driver 1142 receives a control signal from the controller 1112-1 and outputs scan signals to the display panel 1141 in response to the control signal. The gate driver 1142 may include the scan driver 130 shown in FIG. 1. For example, the gate driver 1142 may include the stage circuit ST shown in FIG. 3. For example, the gate driver 1142 may include the driver 402, the boosting unit 404, the carry output unit 406, the output units 408a to 408k, the connecting units 412a to 412k, the controller 410, and the reset unit 414 shown in FIG. 4.

The display module 1140 may further include an emission driver. The emission driver outputs an emission control signal to the display panel 1141 in response to the control signal received from the controller 1112-1. The emission driver may be formed separately from the gate driver 1142, or may be integrated into the gate driver 1142.

The source driver 1143 receives the control signal from the controller 1112-1, converts the image data into an analog voltage such as a data signal in response to the control signal, and outputs the data signal to the display panel 1141. The source driver 1143 may include the data driver 120 shown in FIG. 1.

The source driver 1143 may be integrated into another component such as the controller 1112-1. Functions of the interface conversion circuit and the timing control circuit of the controller 1112-1 described above may be integrated into the source driver 1143. The voltage generation circuit 1144 may output various voltages required for driving the display panel 1141.

In an embodiment, the source driver 1143 may convert data corresponding to a red (R) color, a green (G) color, and a blue (B) color included in the image data received from the processor 1110 into a red data signal or a red data voltage, a green data signal or a green data voltage, and a blue data signal or a blue data voltage, respectively, and may provide the data signals to a plurality of pixel columns included in the display panel 1141 during one horizontal period.

The power module 1150 supplies power to the components of the electronic device 1000. The power module 1150 may include a battery which charges a power voltage. Examples of the battery may include a non-rechargeable primary battery, a rechargeable secondary battery, or a fuel cell. The power module 1150 may include a power management integrated circuit (PMIC). The PMIC supplies optimized power to each of the modules described above and modules to be described below. The power module 1150 may include a wireless power transmitting/receiving element electrically connected to the battery. The wireless power transmitting/receiving element may include a plurality of antenna radiators in the form of coils. In an embodiment, at least some components of the power module 1150 and the voltage generation circuit 1144 may be integrated into one component. For example, the voltage generation circuit 1144 may be included in the power module 1150.

The electronic device 1000 may further include the embedded module 1160 and the external module 1170. The embedded module 1160 may include the sensor module 1161, the antenna module 1162, and the sound output module 1163. The external module 1170 may include the camera module 1171, a light module 1172, and the communication module 1173.

The sensor module 1161 may sense an input by the user's body or an input by the pen of the first input module 1131, and generate an electrical signal or data value corresponding to the input. The sensor module 1161 may include at least one of the fingerprint sensor 1161-1, the input sensor 1161-2, or a digitizer 1161-3.

The fingerprint sensor 1161-1 may generate a data value corresponding to the user's fingerprint.

The input sensor 1161-2 may generate a data value corresponding to coordinate information of the input by the user's body or the input by the pen. The input sensor 1161-2 generates, for example, the amount of change in capacitance due to the input as the data value. The input sensor 1161-2 may sense an input by the passive pen, or transmit to and receive data and from the active pen.

The input sensor 1161-2 may measure bio-signals such as blood pressure, moisture, or body fat. For example, when the user contacts a part of the body with a sensor layer or sensing panel and does not move for a certain period of time, the input sensor 1161-2 may sense a bio-signal based on a change in an electric field caused by the part of the body, and output information desired by the user to the display module 1140.

The digitizer 1161-3 may generate a data value corresponding to the coordinate information of the input by the pen. The digitizer 1161-3 generates the amount of electromagnetic change by the input as the data value. The digitizer 1161-3 may sense the input by the passive pen, or transmit to and receive data and from the active pen.

At least one of the fingerprint sensor 1161-1, the input sensor 1161-2, or the digitizer 1161-3 may be implemented as a sensor layer formed on the display panel 1141 through a continuous process. At least one of the fingerprint sensor 1161-1, the input sensor 1161-2, or the digitizer 1161-3 may be located above the display panel 1141, and one of the fingerprint sensor 1161-1, the input sensor 1161-2, or the digitizer 1161-3, for example, the digitizer 1161-3, may be located below the display panel 1141.

Two or more of the fingerprint sensor 1161-1, the input sensor 1161-2, or the digitizer 1161-3 may be formed to be integrated into one sensing panel through the same process. When integrated into one sensing panel, the sensing panel may be located between the display panel 1141 and a window located above the display panel 1141. However, the present disclosure is not limited thereto. For example, the sensing panel may be located on the window, and the position of the sensing panel is not particularly limited.

At least one of the fingerprint sensor 1161-1, the input sensor 1161-2, or the digitizer 1161-3 may be embedded in the display panel 1141. For example, at least one of the fingerprint sensor 1161-1, the input sensor 1161-2, or the digitizer 1161-3 may be simultaneously formed through a process of forming devices (e.g., a light emitting device, a transistor, or the like) included in the display panel 1141.

In addition, the sensor module 1161 may generate an electrical signal or data value corresponding to an internal state or an external state of the electronic device 1000. The sensor module 1161 may further include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 1162 may include one or more antennas for transmitting or receiving signals or power externally. According to an embodiment, the communication module 1173 may transmit a signal to or receive a signal from the external electronic device 2000 through an antenna suitable for a communication method. An antenna pattern of the antenna module 1162 may be integrated into one component (e.g., the display panel 1141) of the display module 1140 or the input sensor 1161-2.

The sound output module 1163 is a device for outputting a sound signal to the outside of the electronic device 1000, and may include, for example, a speaker used for general purposes such as multimedia playback or recording playback, and a receiver used exclusively for receiving incoming calls. According to an embodiment, the receiver may be formed integrally with or separately from the speaker. A sound output pattern of the sound output module 1163 may be integrated into the display module 1140.

The camera module 1171 may capture still images and film videos. According to an embodiment, the camera module 1171 may include one or more lenses, image sensors, or image signal processors. The camera module 1171 may further include an infrared camera capable of measuring the presence or absence of the user, the position of the user, a gaze of the user, and the like.

The light module 1172 may provide light. The light module 1172 may include a light emitting diode or a xenon lamp. The light module 1172 may operate in conjunction with the camera module 1171 or may operate independently from the camera module 1171.

The communication module 1173 may support establishment of a wired or wireless communication channel between the electronic device 1000 and the external electronic device 2000, and communication through the established communication channel. The communication module 1173 may include a wireless communication module such as a cellular communication module, a near field communication module, or a global navigation satellite system (GNSS) communication module, or a wired communication module such as a local area network (LAN) communication module or a power line communication module. The communication module 1173 may communicate with the external electronic device 2000 via a local area network such as Bluetooth, Wi-Fi direct, or infrared data association (IrDA), or a long distance communication network such as a cellular network, the Internet, or a computer network such as a LAN or a wide area network (WAN). The various types of communication modules 1173 described above may be implemented as one chip or may be implemented as separate chips.

The input module 1130, the sensor module 1161, the camera module 1171, and the like may be utilized to control the operation of the display module 1140 in conjunction with the processor 1110.

The processor 1110 outputs commands or data to the display module 1140, the sound output module 1163, the camera module 1171, or the light module 1172 based on input data received from the input module 1130. For example, the processor 1110 may generate image data in response to input data applied through a mouse, an active pen, or the like and output the image data to the display module 1140, or may generate command data in response to the input data and output the command data to the camera module 1171 or the light module 1172. When input data is not received from the input module 1130 for a certain period of time, the processor 1110 may switch an operation mode of the electronic device 1000 to a low power mode or a sleep mode to reduce power consumed by the electronic device 1000.

The processor 1110 outputs commands or data to the display module 1140, the sound output module 1163, the camera module 1171, or the light module 1172 based on sensing data received from the sensor module 1161. For example, the processor 1110 may compare the fingerprint information of the user received from the fingerprint sensor 1161-1 with the authentication data stored in the memory 1120, and then execute an application according to the comparison result. The processor 1110 may execute a command or output corresponding image data to the display module 1140 based on the sensing data sensed by the input sensor 1161-2 or the digitizer 1161-3. When the sensor module 1161 includes a temperature sensor, the processor 1110 may receive temperature data from the sensor module 1161, and further perform luminance correction or the like on the image data based on the temperature data.

The processor 1110 may receive the determined data about the presence or absence of the user, the position of the user, and the gaze of the user from the camera module 1171. The processor 1110 may further correct luminance of the image data based on the determined data. For example, when the processor 1110 determines the presence or absence of the user through an input from the camera module 1171, the processor 1110 may output the image data of which luminance is corrected to the display module 1140 through the data conversion circuit 1112-2 or the gamma correction circuit 1112-3.

At least some of the above-described components may be connected to each other through a communication method between peripheral devices, for example, a bus, a general purpose input/output (GPIO), a serial peripheral interface (SPI), a mobile industry processor interface (MIPI), or an ultra-path interconnect (UPI) link and may exchange signals (e.g., commands or data) with each other. The processor 1110 may communicate with the display module 1140 through a mutually agreed interface, for example, one of the above-described communication methods may be used, but communication methods are not limited thereto.

FIGS. 12 to 15 are diagrams illustrating examples of an electronic device according to various embodiments.

Referring to FIG. 12, the display device according to an embodiment of the present disclosure may be applied to smart glasses. The smart glasses may include a frame 111 and lens portions 112. The smart glasses may be a wearable electronic device which can be worn on the user's face, and may have a structure in which a part of the frame 111 is folded or unfolded. For example, the smart glasses may be a wearable device for augmented reality (AR).

The frame 111 may include a housing 111b supporting the lens portions 112 and leg portions 111a for wearing by the user. Each of the leg portions 111a is connected to the housing 111b by a hinge and may be folded or unfolded.

A battery, a touch pad, a microphone, and/or a camera may be embedded in the frame 111. In addition, a projector which outputs light and/or a processor which controls an optical signal or the like may be embedded in the frame 111.

The lens portions 112 may be optical members which transmit or reflect light. The lens portions 112 may include glass and/or a transparent synthetic resin.

The display device according to an embodiment of the present disclosure may be applied to the lens portions 112. For example, the user may recognize an image displayed by an optical signal transmitted from the projector of the frame 111 through the lens portions 112. For example, the user may recognize information, such as a time or a date, displayed on the lens portions 112.

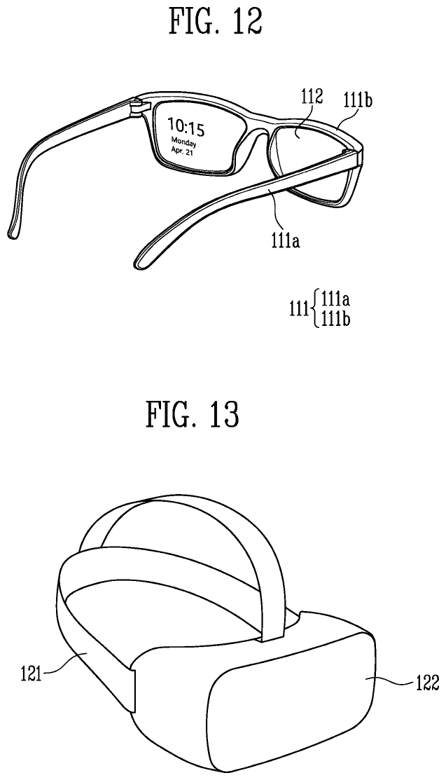

Referring to FIG. 13, the display device according to an embodiment of the present disclosure may be applied to a head-mounted display (HMD). The HMD may include a head-mountable band 121 and a display accommodating case 122. For example, the HMD may be a wearable electronic device which is wearable on the user's head.

The head-mountable band 121 is connected to the display accommodating case 122, so that the display accommodating case 122 can be fixed. The head-mountable band 121 may include a horizontal band and a vertical band for fixing the HMD to the user's head. The horizontal band may surround sides of the user's head, and the vertical band may surround an upper part of the user's head. However, embodiments of the present disclosure are not necessarily limited thereto, and the head-mountable band 121 may be implemented in the form of a head-mountable band 121, eyeglass frame or a helmet.

The display accommodating case 122 accommodates the display device and may include at least one lens. At least one lens may provide an image to the user. For example, the display device according to an embodiment of the present disclosure may be applied to a left-eye lens and a right-eye lens implemented in the display accommodating case 122.

Referring to FIG. 14, the display device according to an embodiment of the present disclosure may be applied to a smartwatch. The smartwatch may include a display portion 131 and a strap portion 133. The smartwatch is a wearable electronic device, and the strap portion 133 may be mounted on the user's wrist. The display device according to an embodiment of the present disclosure may be applied to the display portion 131. For example, the display portion 131 may provide image data including information such as a time or a date.

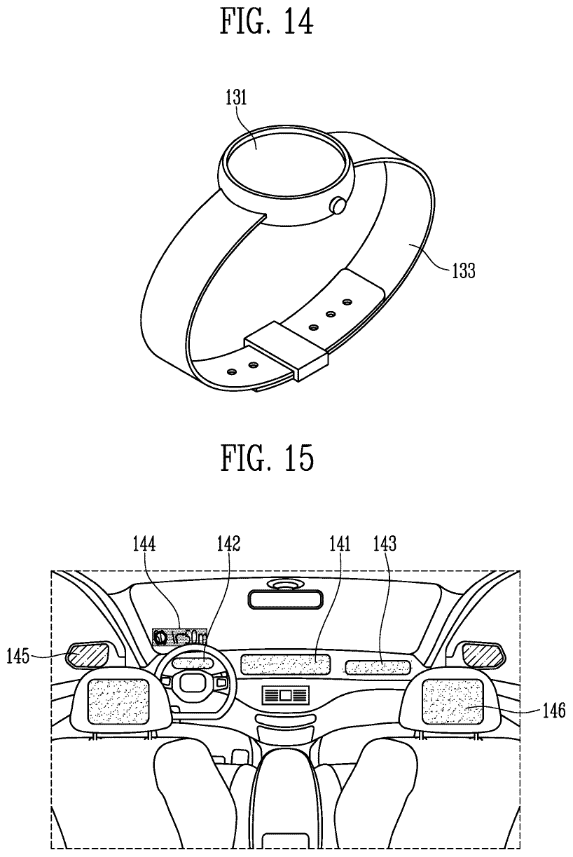

Referring to FIG. 15, the display device according to an embodiment of the present disclosure may be applied to an automotive display. For example, the automotive display may refer to an electronic device provided inside and outside a vehicle to provide image data.

For example, the display device according to an embodiment of the present disclosure may be applied to at least one of an infotainment panel 141, a cluster 142, a co-driver display 143, a head-up display 144, a side mirror display 145, or a rear seat display 146 provided in the vehicle.

According to a stage circuit, a display device including the same, and an electronic device according to embodiments of the present disclosure, one stage circuit may supply a plurality of scan signals (and/or initialization signals), thereby minimizing or reducing a mounting area.

According to the stage circuit, the display device including the same, and the electronic device according to embodiments of the present disclosure, a voltage of a connection control line may be controlled using a reset signal during a sensing period, thereby ensuring the driving reliability.

However, the effects of the present disclosure are not limited to the effects described above, and may be extended without departing from the spirit and scope of the present disclosure.

Although certain embodiments have been described herein, other embodiments and variations may be derived from the above description. Accordingly, it should be noted that the above-described embodiments are for the purpose of description and are not intended to limit the meaning and the scope of the disclosure described in claims. In addition, those skilled in the art may understand that various modifications are possible within the scope of the technical spirit of the disclosure as set forth in the following claims.

What is claimed is:

1. A stage circuit, comprising:
a driver connected to a first power input terminal, a second power input terminal, a third power input terminal and a fourth power input terminal, and configured to control voltages of a first node and a second node;
a controller connected to the first power input terminal, the second power input terminal, a first carry input terminal, a second carry input terminal, an initialization terminal and the driver, and configured to control a voltage of a connection control line;
a plurality of output units disposed in the stage circuit, each of the plurality of output units configured to output an enable scan signal or an enable initialization signal in response to a voltage of a local node connected to each of the plurality of output units;
a plurality of connecting units connected to the plurality of output units, each of the plurality of connecting units configured to control an electrical connection between the first node and the local node connected to each of the plurality of connecting units in response to the voltage of the connection control line; and
a reset unit connected to the second node, the second power input terminal, a fifth power input terminal and a reset input terminal to control the voltage of the connection control line.

2. The stage circuit according to claim 1, wherein first power is input through the first power input terminal, second power is input through the second power input terminal, third power is input through the third power input terminal, fourth power is input through the fourth power input terminal, and fifth power is input through the fifth power input terminal, and
wherein the second power has a positive voltage lower than a voltage of the first power, and the third power, the fourth power and the fifth power have negative voltages.

3. The stage circuit according to claim 2, wherein the fifth power has a same voltage as the third power or the fourth power.

4. The stage circuit according to claim 2, wherein the reset unit comprises:
at least one first reset transistor connected between the connection control line and the fifth power input terminal, and including a gate electrode connected to the second node; and
a second reset transistor connected between the connection control line and the second power input terminal, and including a gate electrode connected to the reset input terminal.

5. The stage circuit according to claim 1, wherein each of the plurality of connecting units electrically connects the first node to the local node during a first period when the first node has a high-level voltage, and disconnects the first node from the local node during a second period when the first node has a voltage higher than the high-level voltage.

6. The stage circuit according to claim 1, further comprising:
a carry output unit connected to a carry clock input terminal and the third power input terminal, and configured to connect a carry output terminal to the carry clock input terminal or to the third power input terminal in response to the voltages of the first node and the second node.

7. The stage circuit according to claim 6, wherein a carry clock signal input through the carry clock input terminal is supplied as a carry signal of the stage circuit to a previous stage circuit and a next stage circuit, and
wherein a carry signal from the previous stage circuit is input through the first carry input terminal, and a carry signal from the next stage circuit is input through the second carry input terminal.

8. The stage circuit according to claim 6, wherein the carry output unit comprises:
a first carry transistor connected between the carry clock input terminal and the carry output terminal, and including a gate electrode connected to the first node; and
a second carry transistor connected between the carry output terminal and the third power input terminal, and including a gate electrode connected to the second node.

9. The stage circuit according to claim 1, further comprising a boosting unit connected to a boosting clock input terminal, through which a boosting clock signal is input, and the third power input terminal, and configured to connect a voltage control line to the boosting clock input terminal or to the third power input terminal in response to the voltages of the first node and the second node.

10. The stage circuit according to claim 9, wherein the boosting unit comprises:
a first boosting transistor connected between the boosting clock input terminal and the voltage control line, and including a gate electrode connected to the first node;
a second boosting transistor connected between the voltage control line and the third power input terminal, and including a gate electrode connected to the second node; and
a first capacitor connected between the first node and the voltage control line.

11. The stage circuit according to claim 9, wherein each of the plurality of connecting units comprises:
a switching transistor connected between the first node and the local node, and including a gate electrode connected to the connection control line; and
a boosting capacitor connected between the voltage control line and the local node.

12. The stage circuit according to claim 9, wherein the controller comprises:
a control transistor connected between the driver and the connection control line, and including a gate electrode connected to the initialization terminal;
a first control transistor connected between the first power input terminal and the connection control line, and including a gate electrode connected to the first carry input terminal;
a second control transistor connected between the second power input terminal and the connection control line, and including a gate electrode connected to the voltage control line; and
a third control transistor connected between the second power input terminal and the connection control line, and including a gate electrode connected to the second carry input terminal.

13. The stage circuit according to claim 12, wherein the driver comprises:
a first transistor connected between the first power input terminal and a third node;
a second transistor connected between the third node and the first node, and including a gate electrode connected to the initialization terminal; and
a holding capacitor connected between the first power input terminal and a gate electrode of the first transistor.

14. The stage circuit according to claim 13, wherein the control transistor is connected between the third node and the connection control line.

15. The stage circuit according to claim 1, wherein each of the plurality of output units comprises:
a first output transistor connected between a scan clock input terminal, through which one of a plurality of scan clock signals is input, and an output terminal, and including a gate electrode connected to the local node; and
a second output transistor connected between the fourth power input terminal and the output terminal, and including a gate electrode connected to the second node.

16. A display device, comprising:
pixels connected to scan lines, initialization lines and data lines; and
a scan driver including a plurality of stage circuits for supplying an enable scan signal to the scan lines and an enable initialization signal to the initialization lines,
wherein at least one of the plurality of stage circuits comprises:
a driver connected to a first power input terminal, a second power input terminal, a third power input terminal and a fourth power input terminal, and configured to control voltages of a first node and a second node;
a controller connected to the first power input terminal, the second power input terminal, a first carry input terminal, a second carry input terminal, an initialization terminal and the driver, and configured to control a voltage of a connection control line;
a plurality of output units disposed in the one of the plurality of stage circuits, each of the plurality of output units configured to output the enable scan signal or the enable initialization signal in response to a voltage of a local node connected to each of the plurality of output units;
a plurality of connecting units connected to the plurality of output units, each of the plurality of connecting units configured to control an electrical connection between the first node and the local node connected to each of the plurality of connecting units in response to the voltage of the connection control line; and
a reset unit connected to the second node, the second power input terminal, a fifth power input terminal and a reset input terminal to control the voltage of the connection control line.

17. The display device according to claim 16, wherein first power is input through the first power input terminal, second power is input through the second power input terminal, third power is input through the third power input terminal, fourth power is input through the fourth power input terminal, and fifth power is input through the fifth power input terminal, and
wherein the second power has a positive voltage lower than a voltage of the first power, and the third power, the fourth power and the fifth power have negative voltages.

18. The display device according to claim 17, wherein the fifth power has a same voltage as the third power or the fourth power.

19. The display device according to claim 17, wherein the reset unit comprises:
at least one first reset transistor connected between the connection control line and the fifth power input terminal, and including a gate electrode connected to the second node; and
a second reset transistor connected between the connection control line and the second power input terminal, and including a gate electrode connected to the reset input terminal.

20. An electronic device, comprising:
a processor;
a display module displaying an image based on image data supplied from the processor;
pixels included in the display module, and connected to scan lines, initialization lines and data lines; and
a scan driver included in the display module, and including a plurality of stage circuits for supplying an enable scan signal to the scan lines and an enable initialization signal to the initialization lines,
wherein at least one of the plurality of stage circuits comprises:
a driver connected to a first power input terminal, a second power input terminal, a third power input terminal and a fourth power input terminal, and configured to control voltages of a first node and a second node;
a controller connected to the first power input terminal, the second power input terminal, a first carry input terminal, a second carry input terminal, an initialization terminal and the driver, and configured to control a voltage of a connection control line;
a plurality of output units disposed in the one of the plurality of stage circuits, each of the plurality of output units configured to output the enable scan signal or the enable initialization signal in response to a voltage of a local node connected to each of the plurality of output units;
a plurality of connecting units connected to the plurality of output units, each of the plurality of connecting units configured to control an electrical connection between the first node and the local node connected to each of the plurality of connecting units in response to the voltage of the connection control line; and
a reset unit connected to the second node, the second power input terminal, a fifth power input terminal and a reset input terminal to control the voltage of the connection control line.
